(19) United States
(12) Patent Application Publication
(10) Pub. No.: US 2021/0127890 A1
(43) Pub. Date: May 6, 2021

(54) INSULATING AND COOLING LIQUID CONTAINER

(71) Applicant: Pierre Maurice Baston, Philadelphia, PA (US)

(72) Inventor: Pierre Maurice Baston, Philadelphia, PA (US)

(21) Appl. No.: 16/450,515

(22) Filed: Jun. 24, 2019

Related U.S. Application Data
(60) Provisional application No. 62/689,109, filed on Jun. 23, 2018.

(51) Int. Cl. A47J 31/44; A47G 19/22; A47J 31/06; A47J 31/50

(52) U.S. Cl. CPC A47J 31/4432; A47G 19/2288; A47J 31/50; A47J 31/0636; A47J 31/0647; A47J 31/0626

(57) ABSTRACT

A cooling system and method for a fluid container enabling a user to switch between an insulating mode that will keep liquid in the mug hot for hours, and a cooling mode to reduce the beverage temperature quickly when the user is ready to drink. In embodiments of the invention the fluid container is a travel mug with an integrated cooling system. In an embodiment a beverage container may include a compartment to hold a consumable liquid, a cooling mechanism for reducing the temperature of the liquid before consumption, and an insulating space located between the compartment and cooling mechanism, which insulating space may be variable. In an embodiment, a pump may be attached to the exterior of a beverage container in which a bellows or piston may enhance vacuum pressure in the container. In an embodiment, a brewing basket for a beverage container may expand in volume to put brewing ingredients and liquid in contact for brewing, or contract in volume to separate brewing ingredients from the liquid, and be responsive to an external control.

### PRIORITY CLAIM

This application claims priority to U.S. Patent Application No. 62/689,109, filed Jun. 23, 2018, and titled, “INSULATING AND COOLING LIQUID CONTAINER,” the contents of which is incorporated by reference in its entirety.

### BRIEF DESCRIPTION OF THE DRAWINGS

The features and advantages of the present disclosure will be more fully understood with reference to the following detailed description when taken in conjunction with the accompanying figures, wherein:

FIGS. 1-6 are cutaway side views of an embodiment of a travel mug.

FIGS. 7A and 7B are cutaway side views, and FIGS. 7C-7E are cross-sectional views of an alternative embodiment of a travel mug.

FIGS. 8A, 9A and 10A are cutaway side views, and FIGS. 8B, 9B and 10B are cross-sectional views of an alternative embodiment of a travel mug.

FIGS. 11A and 11B are cutaway side views of an alternative embodiment of a travel mug.

FIGS. 12A and 12B are cutaway side views of an alternative embodiment of a travel mug.

FIGS. 13A and 13B are cutaway side views of an alternative embodiment of a travel mug.

FIGS. 14A and 14B are cutaway side views of an alternative embodiment of a travel mug.

FIGS. 15A-15C are cutaway side views of an embodiment of a cap with brewing basket.

FIGS. 16A-16B are cutaway side views, and FIG. 16C is a top view of an alternative embodiment of a cap with brewing basket.

FIG. 17A-17B are cutaway side views of an alternative embodiment of a cap with brewing basket.

FIGS. 18A-18B are cutaway side views of an alternative embodiment of a cap with brewing basket.

FIGS. 19A and 19C are cutaway side views of an inverted-taper brewing basket, and FIGS. 19 B and 19D are perspective views of an alternative embodiment of a cap with brewing basket.

FIG. 20 is a cutaway side view of an alternative embodiment of a cap with brewing basket.

FIGS. 21-27 are cutaway side views of alternative embodiments of a cap with brewing basket.

FIGS. 28-29 are cutaway side views of an embodiment of a travel mug with pump.

FIGS. 30A-30B are cutaway side views of an embodiment of a travel mug with pump.

FIGS. 31A-32B are cutaway side views of an embodiment of a pump.

### DETAILED DESCRIPTION

This invention consists of: a) a cooling system, having multiple embodiments, for a fluid container which in preferred embodiments is a travel mug that allows the user to switch between an insulating mode that will keep liquid in the mug hot for hours, and a cooling mode to reduce the beverage temperature quickly when the user is ready to drink; as well as b) the fluid container itself, in various embodiments, that may feature such a cooling system.

Coffee and tea lovers have long wished for a way to enjoy hot beverages away from home. For a better flavor experience, they have demanded thermally insulated travel mugs that will keep their beverages hot until they are ready to drink them. They have also wished to be able to drink their coffee or tea when they want to drink it—without waiting up to multiple hours for their thermally-insulated beverages to cool to a comfortable drinking temperature.

Recent attempts to cool hot beverages quickly have utilized phase change material (PCM). A number of current products have proven that, whether deployed in submersible capsules or in travel-mug walls, PCM can absorb the heat of a beverage to cool it to a predetermined, safe temperature (around 140° F.), and then maintain that beverage temperature for a period of time.

However, a safe temperature for drinking is a poor temperature for brewing coffee or tea. Coffee experts say the best flavor is extracted from coffee beans at about 195-205° F. The ideal brewing temperature for black tea (85% of US tea consumption) is 208-212° F. Yet mugs with PCM in their walls start to cool a liquid as soon as it is poured in, so brewing tea or coffee within these devices cannot be accomplished at the high temperatures that yield the most flavorful results. Most travel mug users brew tea or coffee in a teapot or coffeemaker first, and then pour the ready beverage into their travel mug for consumption on the go. But since they may not drink their beverage until many hours later, the flavor, though fully extracted, may not be fresh.

In contrast, the current invention allows a user to enjoy fresh-brewed coffee or tea, made on the spot and cooled to drinking temperature in a few minutes, from water at the high temperatures required for richest taste.

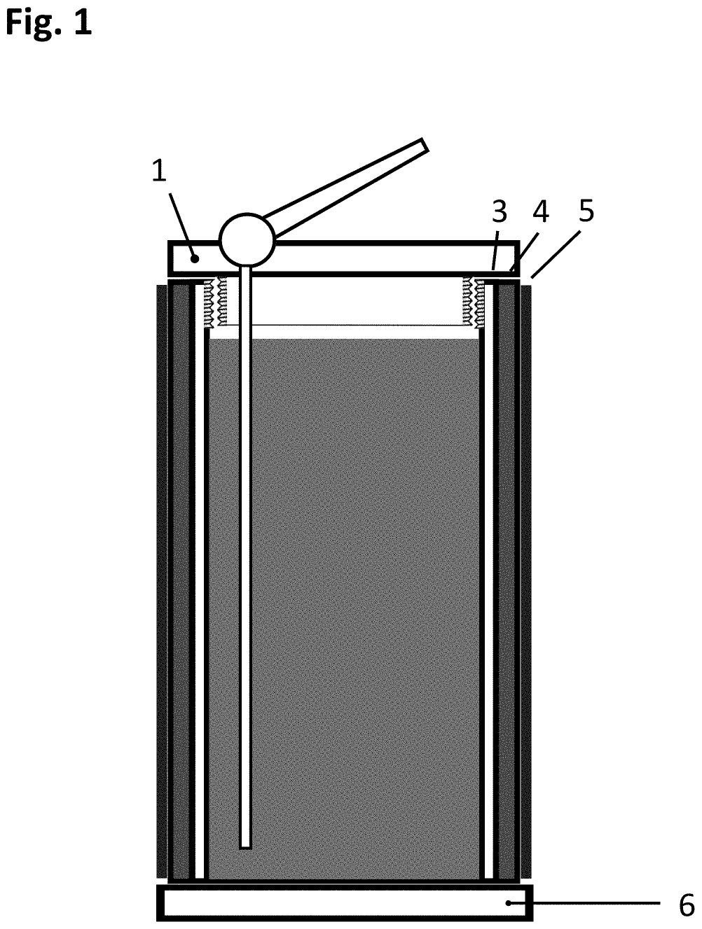

FIG. 1 is a cutaway side view of an embodiment of the invention in the form of a portable travel mug with a system for keeping the contained beverage hot during transport, and then cooling it to a safe and comfortable temperature for drinking when the user chooses. In this embodiment, the travel mug is generally cylindrical, and of a size convenient for carrying in handbag, briefcase, or backpack. It can fit in standard automobile cup holders, and easily be used while carried in one hand.

The mug has a double-walled cap 1, shown in FIG. 1 with a folding mouthpiece connected to an internal drinking straw. The mouthpiece is removable to enable the user to opt to drink directly from the cap hole, or to pour the beverage into a cup or another receptacle. The beverage is contained within a tank 2, which may have threads or other means at the top to allow the cap to be tightly secured to it. A cylindrical channel 3, which immediately surrounds the tank, is shown empty. A compartment 4, which immediately surrounds channel 3, contains heat absorbing phase change material (PCM). A sleeve 5, which immediately surrounds PCM compartment 4, contains or consists of highly thermally-conductive material like, for example, aluminum or copper. The mug has a double-walled bottom 6, which removably attaches to tank 2 in such a way as to hold conductive sleeve 5 in place.

When the device is used, to start, the cap is removed and either a hot beverage like tea or coffee already brewed, or hot water to be used later for brewing within the container, is introduced into tank 2.

Next, the cap is securely attached again. When the mouthpiece is folded closed, the device is leak-proof and can be transported without fear of spills. The air insulation in channel 3 will help retain the heat of the liquid in tank 2.

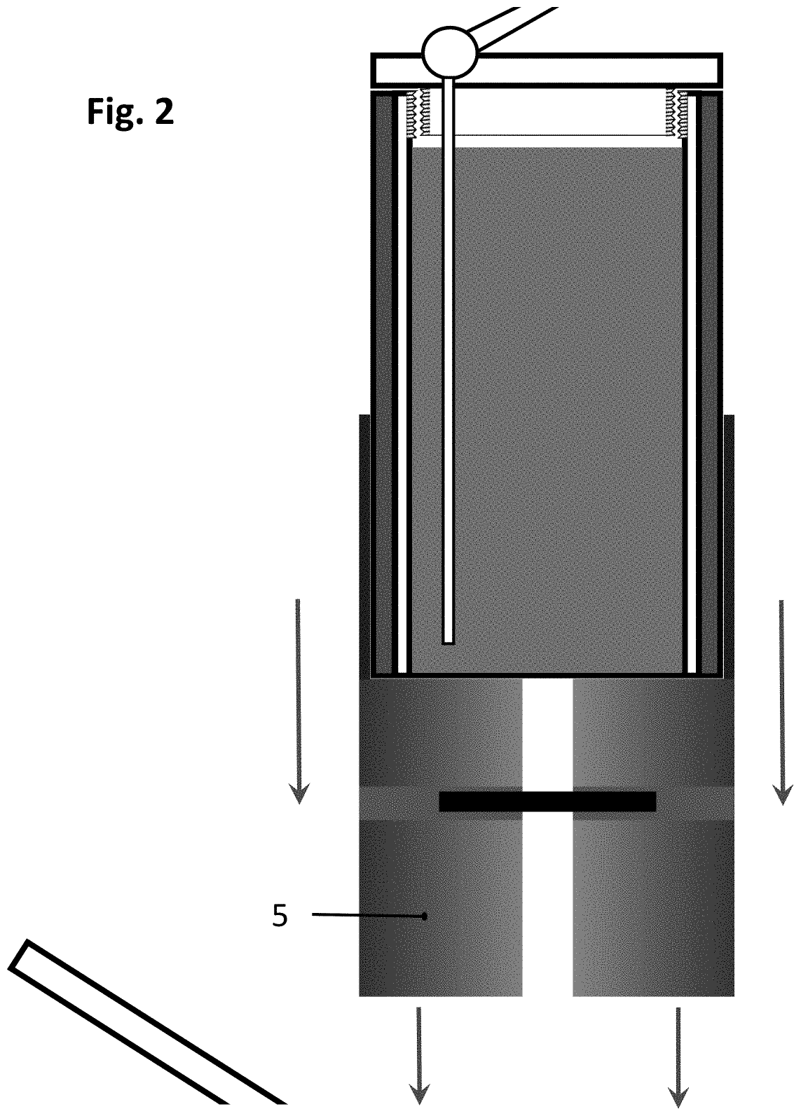

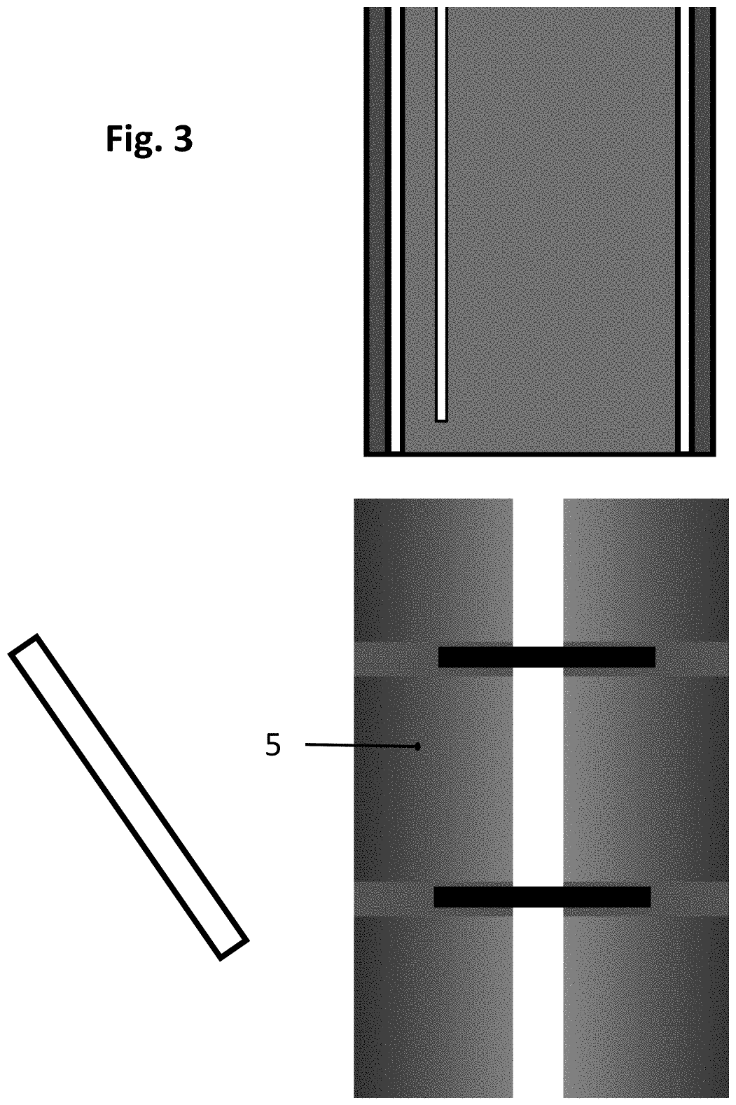

Later, when the user is away from home and on the go, and wishes to consume his beverage, he may find that the beverage is still too hot to drink. To cool the beverage, he starts by removing bottom 6, and then removing conductive sleeve 5, as shown in FIG. 2 and FIG. 3. Sleeve 5 may consist of two or more sections separated by a gap or gaps, and connected by tabs or bars. The connecting bars may be set into grooves that allow the sections of cylindrical sleeve 5 to slide together or apart.

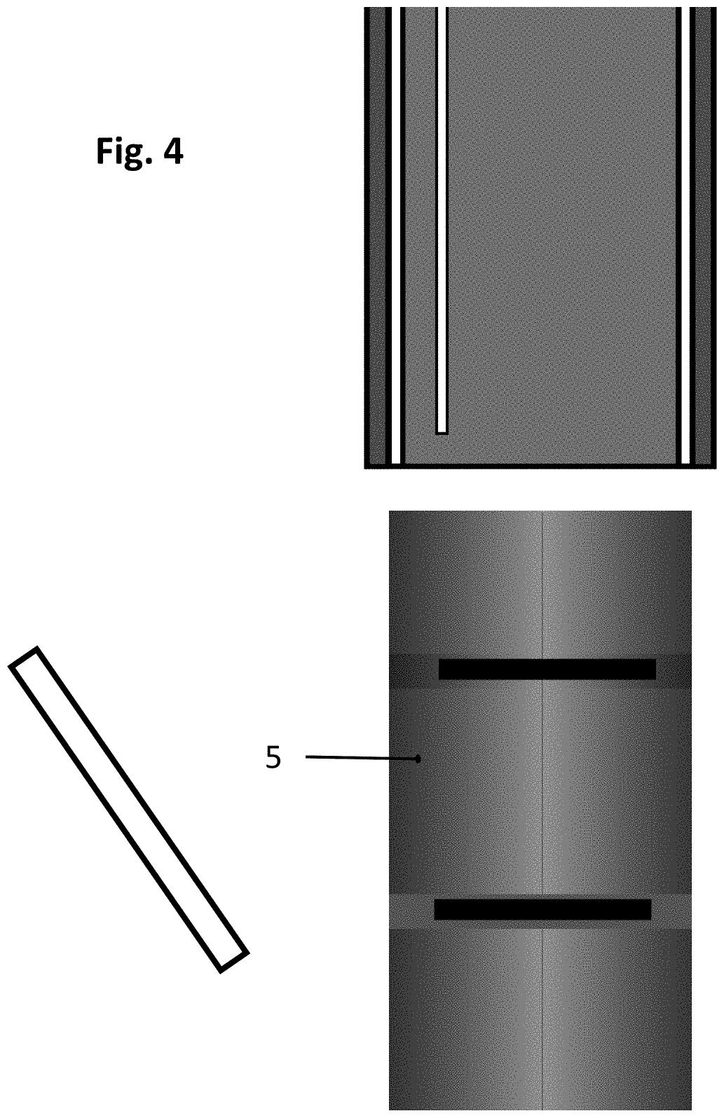

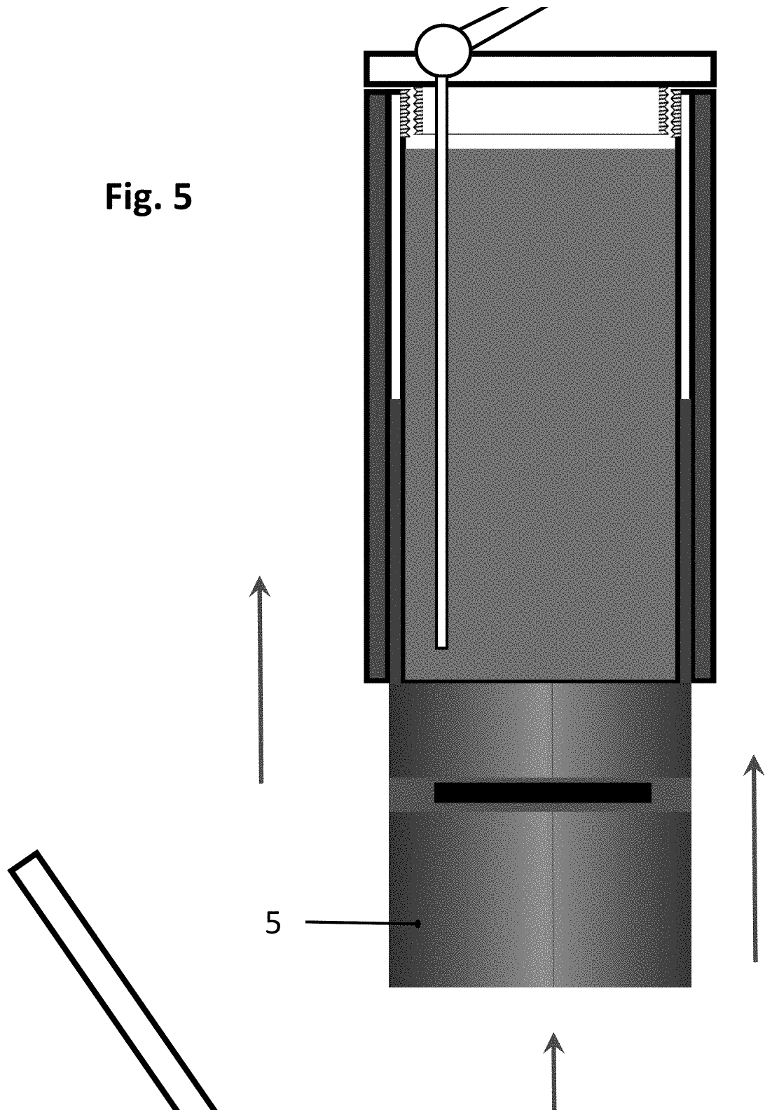

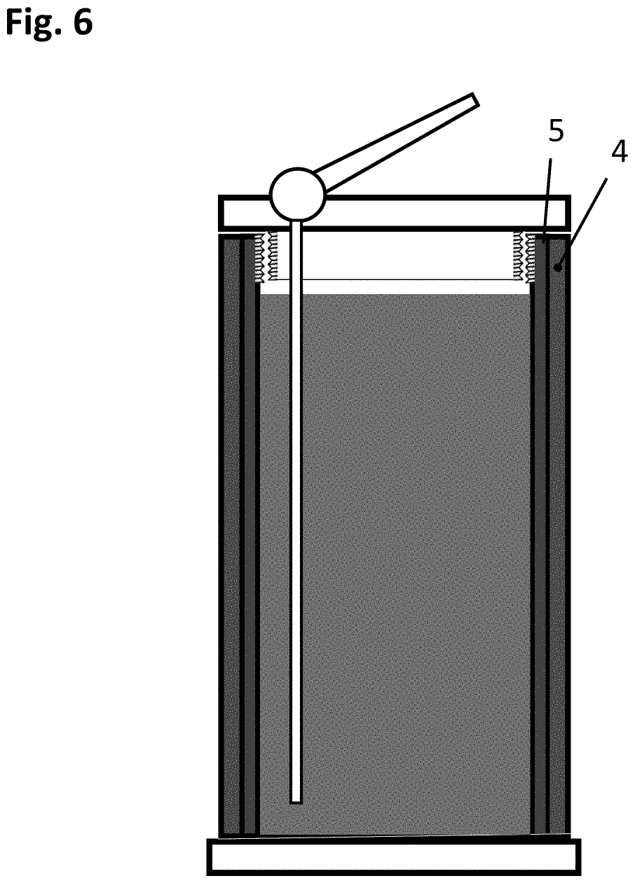

The user now slides the segments of sleeve 5 together, so as to eliminate the gaps and reduce the diameter of the cylindrical sleeve, as shown in FIG. 4. He then slides the newly contracted sleeve 6 into channel 3, into which the sleeve now fits perfectly, as shown in FIG. 5 and FIG. 6.

Filling the formerly insulating gap of channel 3 with conductive sleeve 5 now puts the hot beverage in tank 2 in thermal contact with PCM compartment 4. The PCM, chosen to have a melting temperature of about 140° F., absorbs the heat from the beverage and cools it to that ideal drinking temperature within a few minutes. The user then safely dispenses and consumes his beverage by any one of the methods mentioned earlier.

The advantages offered by this design over prior art in which the PCM and liquid tank are always in thermal communication are:

(1) Insulating the beverage during transport and cooling it right before consumption may keep the beverage hot longer, and thereby prolong the window of time during which the beverage can be consumed before it becomes too cold (i.e., significantly colder than 140° F.).

(2) Users can brew tea or coffee at near-boiling temperatures within the device, for richest flavor, before the beverage is cooled. By contrast, devices of prior art employing PCM start cooling hot water to 140° F. as soon as it is poured in, and brewing tea or coffee at that low temperature generally produces weak taste.

(3) For the reasons just described, this device enables users to brew on the spot and at the moment of consumption, for freshest flavor. By contrast, to avoid brewing at sub-optimal temperatures within devices of prior art, users of those devices must first brew their tea or coffee in an external pot before filling the devices with the finished beverage—beverage which they may not consume until hours later.

Users of embodiments of this invention can brew within the device by inserting tea bags or coffee pods or other brewing elements, whether loose or packaged, into tank 2. But this invention also encompasses embodiments that comprise configurations with integral or detachable containers, compartments, enclosures, baskets, cups, etc. that may hold brewing elements, including the myriad brewing enclosures or attachments well known to those skilled in the art.

In alternative embodiments, there may be no conductive sleeve 5. PCM compartment 4 may normally constitute the outer sidewall of the device. PCM compartment 4 may have two or more sections normally separated by gaps. To cool beverage, it is PCM compartment 4 that the user would remove, compress, and then slide into channel 3 to achieve direct thermal contact with tank 2, without mediation of a conductive sleeve.

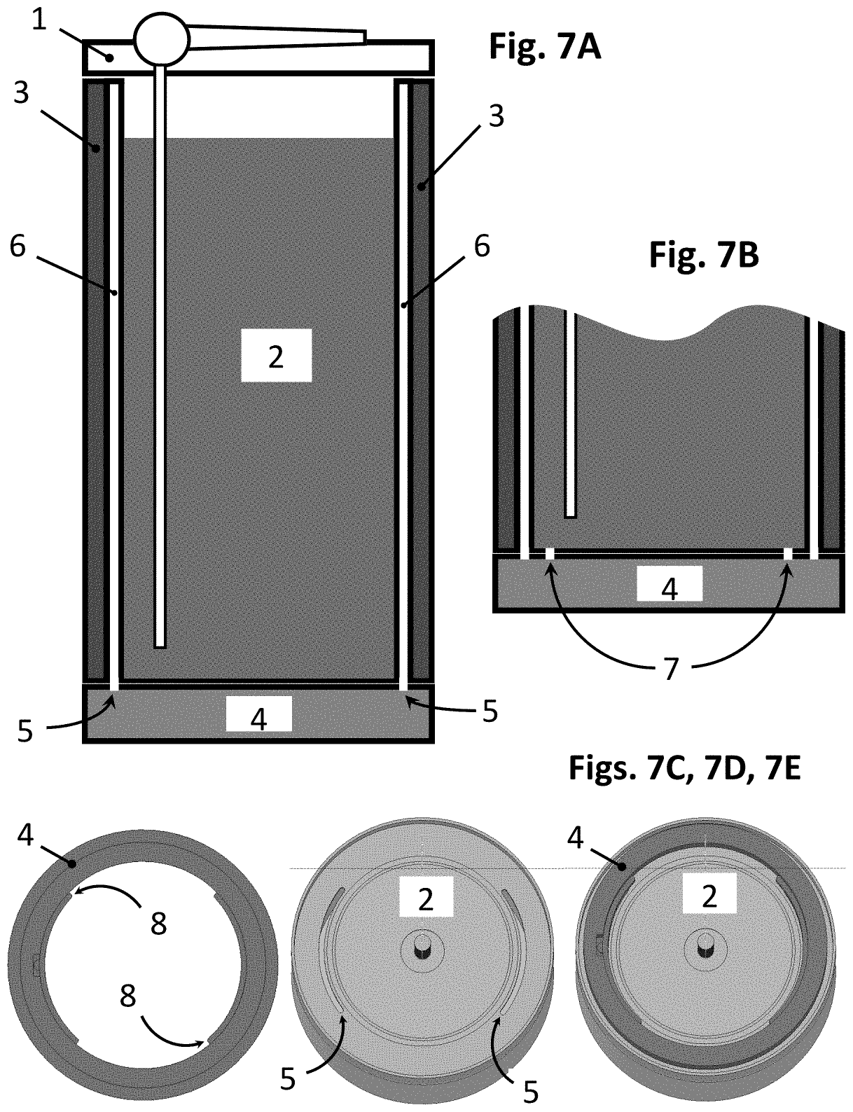

In other embodiments, a conductive liquid might be used to thermally connect beverage and PCM. As shown in FIG. 7A, the device may consist of cap 1, beverage tank 2, PCM (phase change material) sleeve 3, liquid coolant reservoir 4, connector-space openings 5, and connector space 6. The cylindrical PCM sleeve 3 is separated from beverage tank 2 by connector space 6. Space 6, which may normally contain a vacuum, will thermally insulate tank 2 and maintain the temperature of hot liquid in the tank as typical insulated travel mugs do. Reservoir 4 holds a liquid which may be a 30% propylene glycol-water mix, and connects to space 6 through openings 5 when the reservoir is twisted so that its flanges do not block openings 5.

FIGS. 7C-7E are cross-sectional views, looking up from reservoir 4, showing flanges 8 projecting from the top edge of reservoir 4 (FIG. 7C), and openings 5 at the bottom of the device's main body (FIG. 7D). Flanges 8 either leave openings 5 unblocked, or, when twisted 90° from the open position, block openings 5 and prevent the passage of the coolant (FIG. 7E).

In use, tank 2 may be filled with hot water, and reservoir 4 twisted so as to block openings 5 to contain the coolant within the reservoir and leave space 6 a vacuum. The device, now in insulating mode, will keep the water in the tank hot for hours. Later, when the user is ready to drink, he will drop tea leaves or ground coffee into the tank and allow them/it to steep at the appropriate (high) temperature. Then a few minutes later, when the brewing is done, the user will twist reservoir 4 to unblock openings 5, and invert the device to fill space 6 with the liquid coolant. Now the hot beverage in tank 2 will be in thermal contact with the PCM through the intermediate coolant in space 6.

The selected PCM may have a melting point equal to the desired, safe drinking temperature (approximately 140° F.). After a relatively short time in thermal contact with the PCM, the beverage will cool to the PCM's melting temperature, as heat passes from beverage to PCM through the intermediate cooling liquid. Additionally, the beverage in this device will remain at the target drinking temperature for some time, because even as the PCM slowly loses its heat energy to the ambient environment, it will remain at its melting temperature until it fully solidifies again. The beverage, thermally connected to the PCM, will consequently stay at that temperature for an equally long time.

The device may remain inverted until cooling is complete. Alternatively, the user may lock the coolant in space 6 by rotating reservoir 4's flanges, and then invert the device again so that it remains upright during cooling.

In preferred embodiments, connector space 6 is a vacuum to keep the liquid contents of tank 2 hot for the maximum amount of time. However, the space could normally contain air or any other relatively thermally-insulating fluid.

Propylene glycol is non-toxic, and a 30% mixture has a freezing temperature of about 8° F., and a boiling temperature of about 216° F., so it should neither freeze nor boil under most conditions. But any relatively thermally-conductive fluid with suitable qualities of safety, stability and viscosity may be deployed in reservoir 4 and space 6.

PCM is a preferred cooling material to be deployed in sleeve 3, but any heat-absorbing material may be used. And sleeve 3 may be omitted completely so that the ambient environment acts as the cooling agent with which the beverage tank becomes thermally connected when connector space 6 is filled with a thermally conductive medium.

In some embodiments, liquid in tank 2 itself may be used to flood connector space 6 to initiate the cooling mode, without need for a special coolant, as illustrated in FIG. 7B for one example among many commonly known ways. Openings 7 between tank 2 and reservoir 4 could normally be blocked by flanges projecting from the top edge of reservoir 4, in the same way flanges 8 are shown blocking openings 5 in FIG. 7E. The tank would be filled with hot liquid, and reservoir 4 and connector space 6, containing air, would insulate it. When the user was ready to drink, he would rotate reservoir 4 so that its flanges would unblock openings 7 and allow beverage to enter reservoir 4, pass through openings 5, and rise within space 6 to the same level as beverage still in tank 2 (due to the force of gravity). Beverage in space 6 will now thermally connect tank 2 and PCM compartment 3, and all of the beverage can be cooled.

All embodiments may deploy a cap, like cap 1 in FIG. 7A, that includes a removable, folding mouthpiece connected to an internal drinking straw. However, any cap design, including the numerous designs in common usage, may be employed.

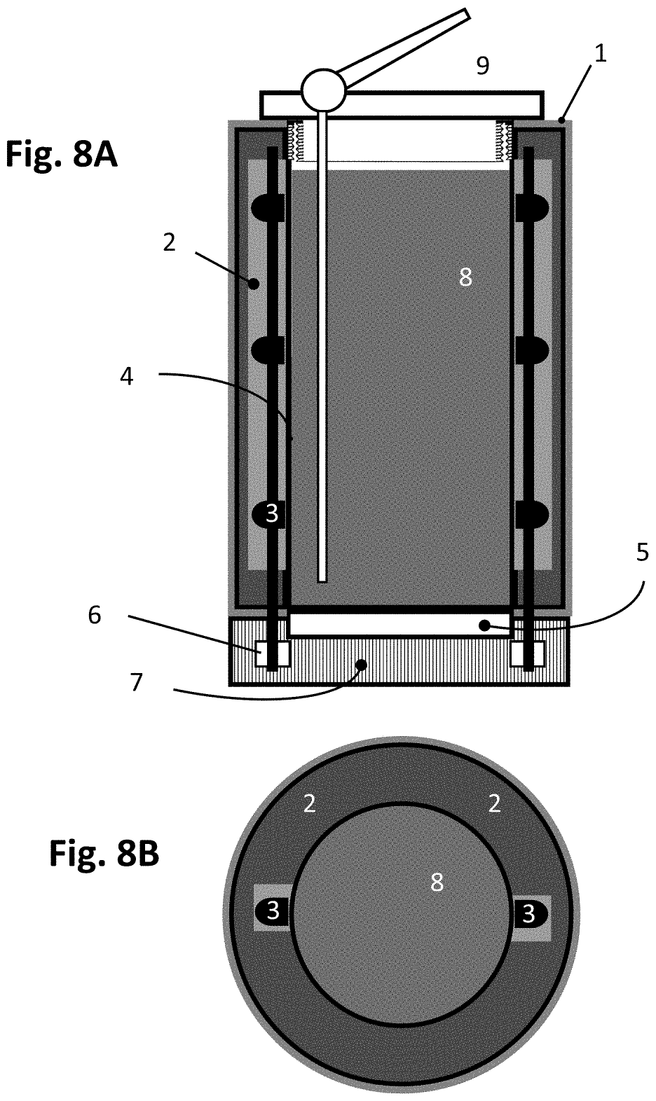

FIGS. 8A-8B illustrate an alternative embodiment. As shown in FIG. 8A, the device comprises a vacuum-insulated cap 9, which may include a detachable folding mouthpiece and internal straw; a water or beverage tank 8; a cylindrical PCM compartment 2 that immediately surrounds tank 8; an elastic membrane 1 that covers the entire outward surface of PCM compartment 2, and pulls compartment 2 in tight against tank 8; dual camshafts 3 lodged in grooves recessed within the inner surface of PCM compartment 2; a vacuum-insulated bottom 5; dual gears 6 at the ends of camshafts 3; and a camshaft-actuating gear ring 7.

FIG. 8B shows a cross-sectional view. When the lifting heads on camshaft 3 are in this position, PCM compartment 2 and tank 8 have complete contact for maximum thermal communication through the tank's sidewall. Membrane 1 is physically cinched and/or chemically adhered and/or otherwise attached to the exterior of tank 8 so as to make a hermetic seal with the tank. Gear ring 7 is an internal gear whose teeth intermesh with the teeth of camshaft gears 6.

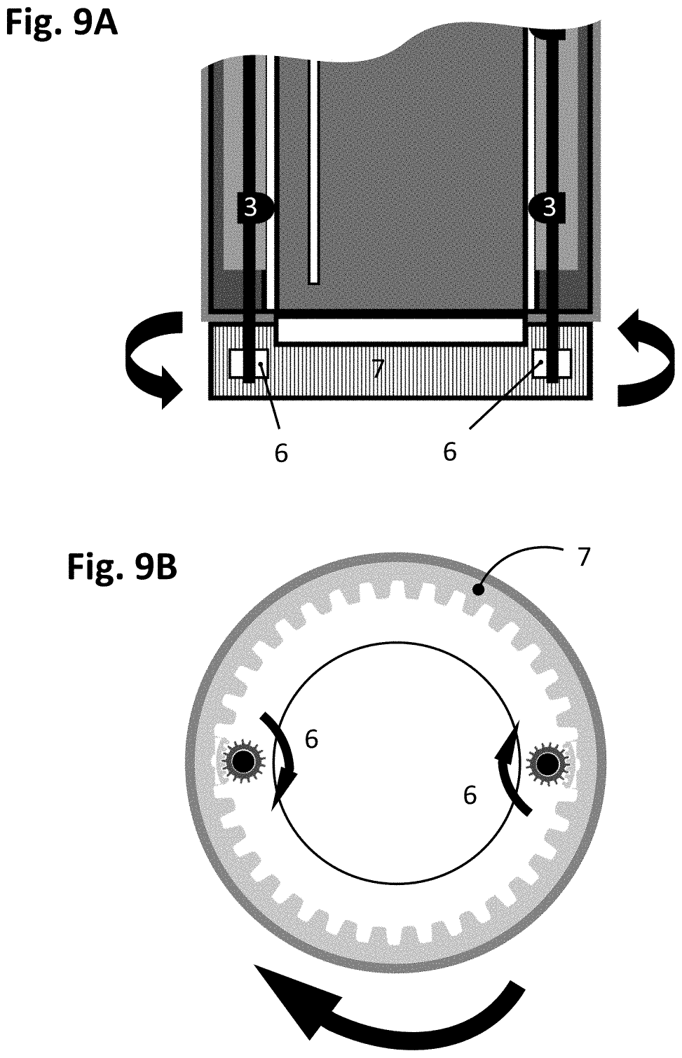

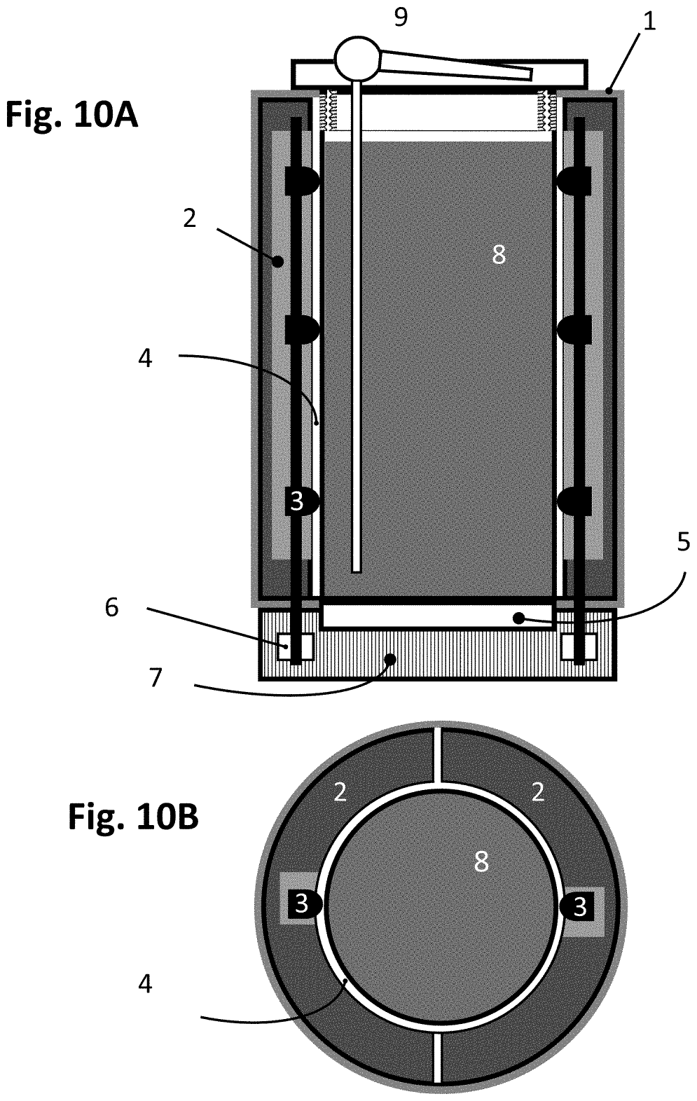

FIGS. 9A and 9B show that when gear ring 7 is rotated, it causes gears 6 and camshafts 3 to rotate horizontally. FIGS. 10A and 10B show that PCM compartment 2 actually consists of 2 sections that can be separated. When gear ring 7 is rotated so that the long ends of the cams on shaft 3 press against the exterior wall of tank 8, the camshafts, which are attached to PCM compartment 2, force the 2 sections of compartment 2 away from tank 8, and a space between compartment 2 and tank 8 is created. The elasticity of membrane 1 allows this expansion. And because membrane 1 is hermetically sealed to the exterior of tank 8 at top and bottom, no ambient air can rush in to fill the newly-formed space. As a result, the separation—vacuum space 4—will insulate tank 8 from compartment 2 and the environment, and keep the liquid within the tank hot for a very long time.

Using the device starts by rotating gear ring 7 to activate vacuum-insulation for the tank as shown in FIGS. 10A and 10B. The user then pours hot beverage (or water for brewing beverage) into tank 8. He replaces cap 9, tosses the mug in his briefcase, and heads to work. Hours later, at work, at the park, or on the bus, when he decides he wants to drink, the mug will have faithfully kept the liquid inside quite hot. If he is brewing on the spot, the user combines brewing material and the hot water for exquisite, full-bodied, fresh-brewed flavor extracted at the optimal (high) brewing temperature. If drinking tea or coffee that has already been brewed, he proceeds directly to cooling it for safe drinking.

To cool, the user rotates gear ring 7 to the position depicted in FIGS. 8A and 8B to eliminate vacuum space 4 and bring PCM compartment 2 tightly up against tank 8. In just a few minutes, the PCM absorbs the tank's heat, and cools it and the beverage inside to 140° F. Additionally, the PCM will keep the mug's contents at this temperature for some time, as the user drinks. However, to maximize the length of time the beverage remains at this temperature, the user can rotate gear ring 7 to its original position and reestablish the insulating vacuum.

The advantages of this design over prior art are as follows:

(1) Vacuum-insulation offers superior thermal efficiency, and will keep liquid in the tank hot a very long time, until the user is ready to cool his beverage to 140° F. and drink.

(2) User operation of the cooling system is simple and easy.

(3) Manufacture is simpler, quicker, and less expensive: Instead of the specialized machinery and machine operators of traditional stainless-steel vacuum-bottle making, only unskilled workers are required to attach the membrane with PCM compartments to the tank wall.

Elastic membrane 1 may be only partly elastic, and may have discrete sections that stretch, and others that are inelastic or rigid or semi-rigid. Membrane 1 may also incorporate reinforcement of Kevlar fabric, metal scales, or other penetration-resistant materials and elements, to prevent loss of vacuum by puncture. Membrane 1 may cover the entire outward surface of PCM compartment 2, or it may merely be hermetically attached to compartment 2 around all edges of the compartment.

One or more one-way valves (not shown) may be inset into membrane 1, as near the side, top or bottom gaps between PCM segments, or between PCM segments and tank, with the inlet of the valve communicating with vacuum space 4, and the valve's outlet leading to the ambient environment. The valve/s would maintain the quality of the vacuum insulation over time. Each time PCM compartment 2 is collapsed onto water tank 8 by rotating gear ring 7, any air that might have managed to contaminate the vacuum space would be expelled via the valve/s.

The camshaft/PCM compartment/membrane mechanism could be made and sold separately for use with any cylindrical travel mug or similar container. It should be understood that the camshaft mechanism depicted is only generally representative, and the concept encompasses variations that may have a different number, size, shape, or placement of cams and shafts, among other variables. This invention also encompasses other means of separating and joining the PCM compartments and liquid tank, including the many such means commonly known to those skilled in the art, like, for example and without limitation, a vise mechanism or levers that pry or pinch, actuated by a twisting, screwing, sliding, pushing or pulling action, or by magnetic attraction and repulsion of parts, or by electrical motor.

Also, in embodiments of the invention, the outer wall of the PCM compartment may be insulated, as, for example and without limitation, by thermally-insulating material constituting the compartment's outer wall itself, or by thermally-insulating material attached to the wall, or by thermally-insulating material constituting or attached to the elastic membrane enclosing the PCM compartment, or by a vacuum space or compartment adjacent to the PCM compartment's outer wall or membrane. Such insulation might further prolong the time that beverage would remain at 140° F. after PCM compartment and tank are connected.

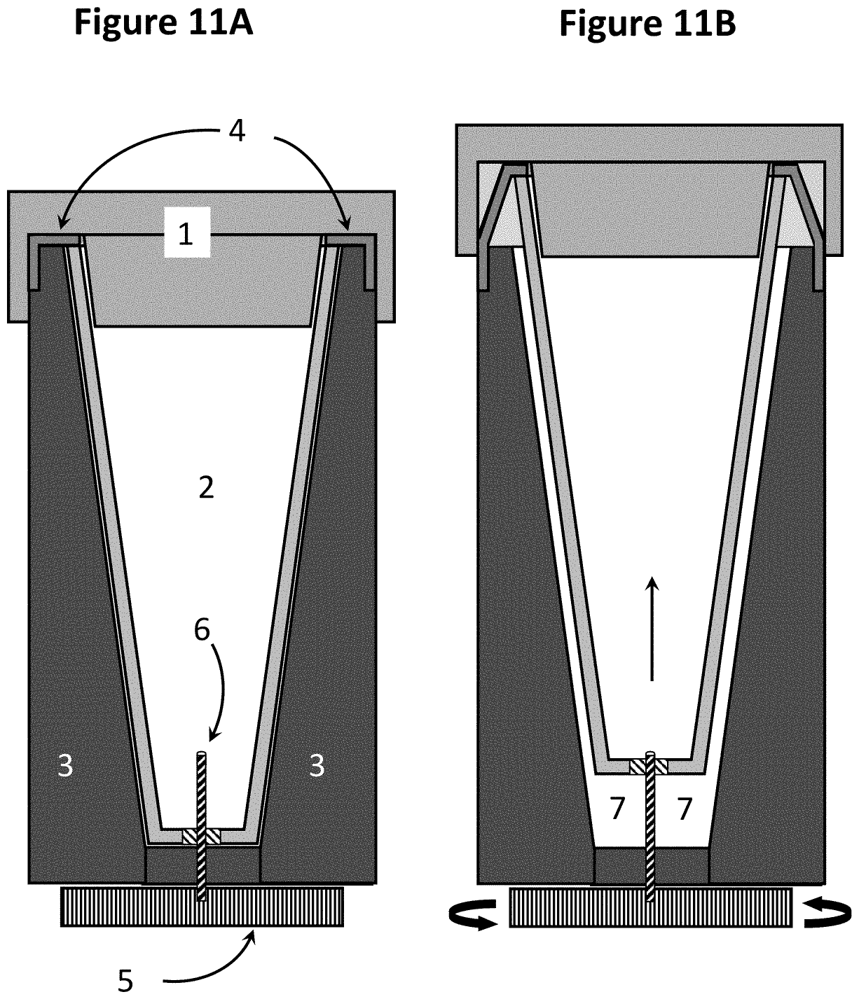

An alternative embodiment of the invention is illustrated in FIGS. 11A and 11B. This embodiment consists of beverage tank 2 which nests perfectly within PCM sleeve 3 and benefits from full, flush contact with the PCM sleeve on sides and bottom to facilitate quick beverage cooling when in the cooling mode, as depicted in FIG. 11A. Tank 2 is somewhat conical, and tapers towards the bottom, and PCM sleeve 3 has a shape to match. Tank 2 is removably sealed by cap 1, which may screw into the inside surface of tank 2 by means of threads on the outer surface of the plug projecting into the tank from the bottom side of cap 1. Cap 1 also disposes of an outer flange that overlaps the top edge of PCM sleeve 3, and slides up and down the sleeve's outer shell.

When in the cooling mode (FIG. 11A), the top edges of tank 2 and PCM sleeve 3 are coterminous. A flexible membrane 4 overwraps the two component edges, and is hermetically sealed to sleeve 3 and tank 2 all around the edges. At the bottom of the device, spindle 6 passes through the bottoms of tank 2 and PCM sleeve 3 to attach to external dial 5. Spindle 6 has threads that engage a threaded nut fixed in the bottom of tank 2. Tank 2 does not rotate, either because of thermally non-conductive rails or posts or other projections from its sides that are lodged in vertical tracks or grooves in the inner surface of PCM sleeve 3 (not shown), or because of other means. Accordingly, when dial 5 and spindle 6 attached to it are rotated, tank 2 can be raised or lowered.

When tank 2 is raised, as in FIG. 11B, the device is in its insulating mode, as the conical shape of tank 2 and PCM sleeve 3 cause the two components to separate at all points. An insulating space 7 is created between components, which the hermetic seal of membrane 4 keeps air from rushing in to fill, so space 7, a vacuum, insulates the beverage in tank 2 very well.

The mating surfaces of tank 2 and PCM sleeve 3, in embodiments, may have plateaus, angles, or other geometric forms designed to increase surface area and/or decrease the amount of vertical displacement necessary to achieve desired vacuum space. The means of separating and joining tank and sleeve, though depicted here as by a particular screwing mechanism, can be accomplished in many known alternative ways, including, without limitation, by simple pulling and pushing.

In an alternative embodiment, illustrated in FIGS. 12A and 12B, beverage tank 2 is conical and tapering towards the bottom, and nests in flush contact with PCM compartment 3. Compartment 3 is topped by a permanently attached threaded ring 4 of thermally non-conductive material, like, for a non-limiting example, a suitable plastic. Ring 4 is supplied with threads. Tank 2 is screwed into ring 4 by means of mating threads at the top of the tank. Tank 2 is topped by a permanently attached tank ring 5, which is thermally non-conductive. Tank ring 5 has a flange that overlaps the top edge of the device, and slides up and down along the outer shell of PCM compartment 3. When the user grips tank ring 5 and twists it in one direction, it lowers tank 2 into flush contact and thermal communication with PCM compartment 3, as shown in FIG. 12A. When tank ring 5 is twisted in the opposite direction, the tank rides up the threads of threaded ring 4 and thereby separates from compartment 3 at all points, to establish the device's insulating mode, as depicted in FIG. 12B. Because threaded ring 4 is thermally non-conductive, as is tank ring 5, tank and PCM are completely thermally isolated from each other. The separation of components creates insulating space 7, which can be a vacuum for maximum insulating efficiency. O-ring 6, embedded within a groove near the top of tank 2, makes a hermetic seal with the wall of compartment 3 and ring 4, to preserve the vacuum created in space 7. O-ring 6 can maintain hermetic contact with the surrounding wall, even when tank 2 and compartment 3 are separated, because the top of tank 2 and threaded ring 4 both have parallel, vertical sides, so vertical movement does not separate them. Only the lower parts of the tank and PCM compartment 3 taper, and therefore separate.

As with other embodiments disclosed above, this embodiment may deploy a one-way valve 8 whose inlet opens onto vacuum space 7, and whose outlet leads to the ambient environment. As with relevant embodiments above, the one-way valve can be of any type, including, as a non-limiting example among many suitable valve types known to those skilled in the art, one with a flexible diaphragm at the valve's outlet. Such a one-way valve can flex outward to allow air to be forced out of the device, but is normally pressed tight against its seat by external air pressure and its pre-formed shape, so air cannot enter the device and spoil the vacuum.

Cap 1 attaches removably to tank ring 5 to allow tank 2 to be filled with liquid. Cap 1 may provide insulation for the tank, including by a vacuum space within it.

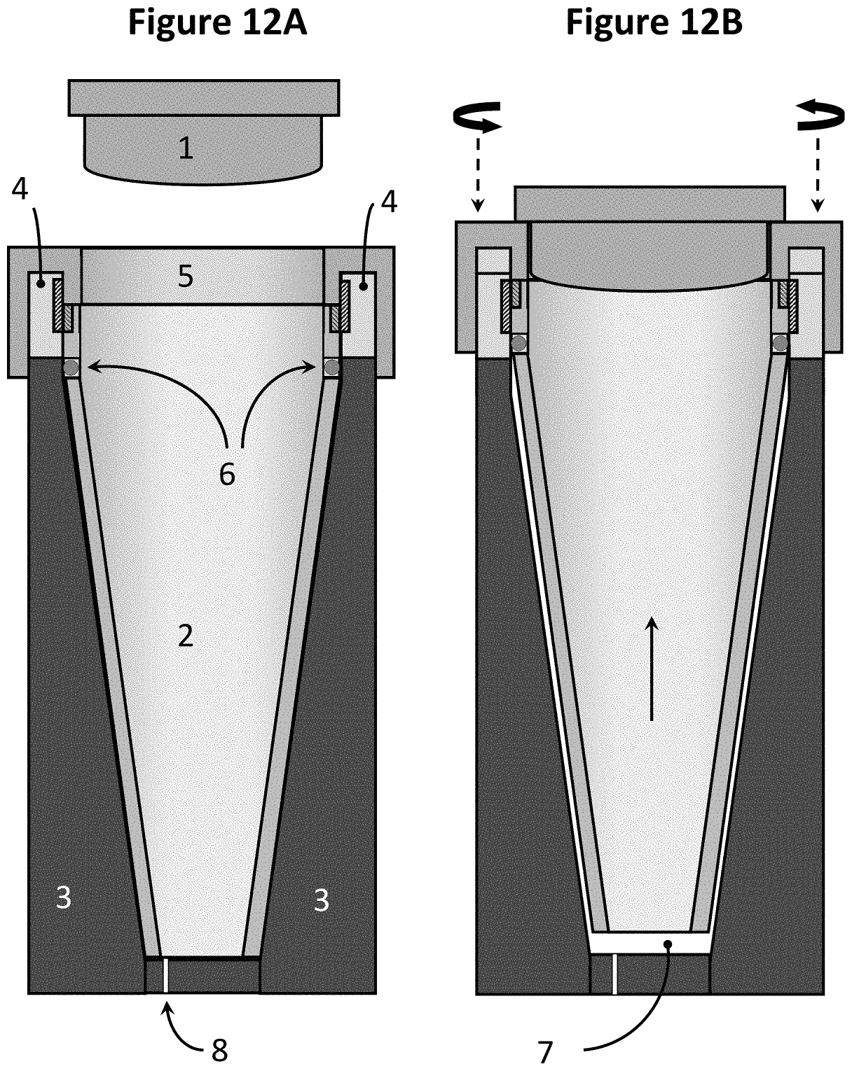

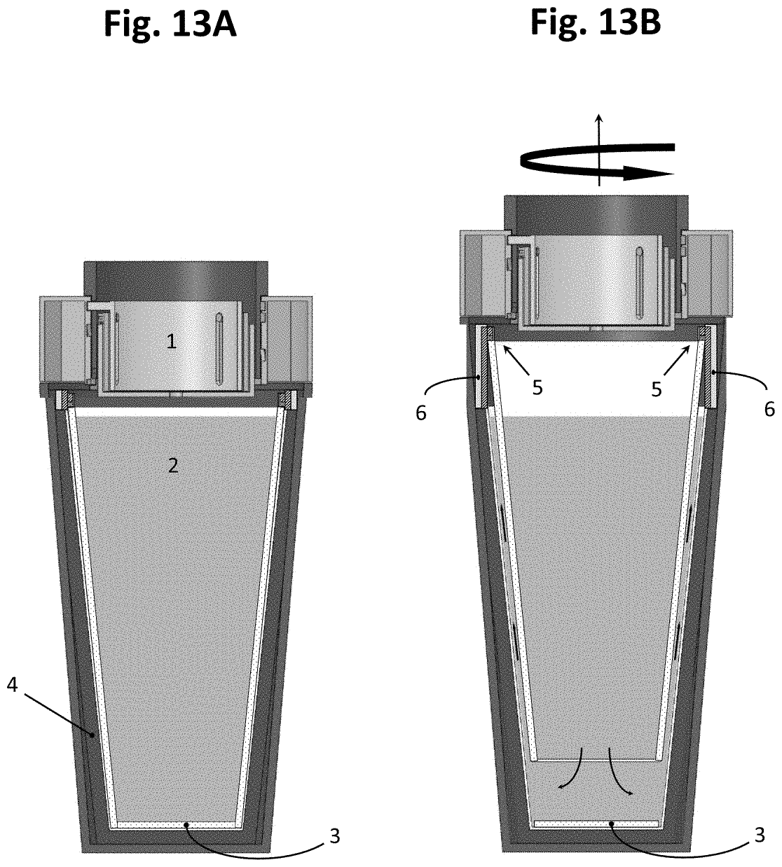

FIGS. 13A and 13B show a preferred embodiment comprising a mug cap 1, beverage-cup sidewall 2, beverage-cup bottom plate 3, PCM compartment 4, threaded beverage-cup ring 5, and threaded PCM ring 6. The cup's sidewall 2 and bottom plate 3 are double-walled, and the 2 walls of each part contain a permanent vacuum between them. Bottom plate 3 is permanently fixed to the bottom of the mug. Cup sidewall 2 press-fits against bottom plate 3 to form a hermetic seal so that sidewall 2 and bottom plate 3, when joined, constitute a chamber that can hold a liquid within it. When hot water is introduced into the beverage cup and the mug is in the insulating mode (FIG. A), the beverage cup and PCM compartment nest in full contact with each other, but there is virtually no heat-loss from beverage to PCM because of the cup's vacuum-insulated sidewall 2 and bottom plate 3.

After brewing, the cooling mode is initiated by screwing apart or otherwise separating cup sidewall 2 from bottom plate 3 (FIG. 13B). As the sidewall of the cup is raised, the press-fit hermetic seal between the cup's sidewall and bottom is broken, and the hot beverage is released to fill the widening space between cup and PCM. This contact between the hot beverage and the PCM-compartment wall will cause the coffee to cool. While convection will eventually cool all of the coffee or tea, occasional agitation by the user will make the cooling happen faster.

After cooling, the operation can be reversed by screwing the cup's sidewall 2 down tightly onto its bottom plate 3, and into full nesting with PCM compartment 4. The beverage, forced back within the vacuum-insulated confines of the cup, will be held at drinking temperature as the user consumes it at his leisure. Alternatively, after cooling, the user can opt to leave his beverage in contact with the PCM, and the PCM rather than the beverage cup's vacuum will maintain drinking temperature.

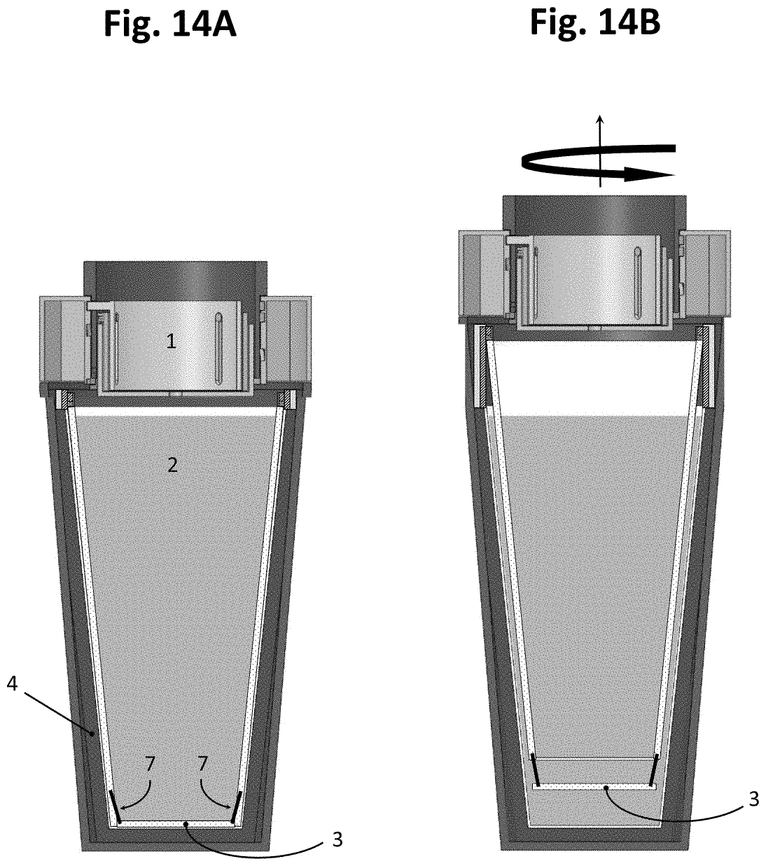

In the alternative embodiment shown in FIG. 14A and FIG. 14B, the area of heat transfer can be increased, and cooling time shortened, by means of a connector or connectors between beverage cup sidewall 2 and bottom plate 3. Bottom plate 3 would not be permanently attached to PCM compartment 4, but would only rest on the PCM wall, in the insulating mode. When the cooling mode is initiated, raising beverage cup sidewall 2 would, by means of connectors 5, lift bottom plate 3 away from the PCM wall, to allow beverage cooling to take place at the bottom of the mug, too.

In various embodiments, the cap of the device may incorporate or accept fixtures that facilitate brewing within the device. Such a brewing basket apparatus for tea, coffee or other infused beverage would permit flavor ingredients to be submerged in water or other brewing liquid, and/or separated from the brewing liquid, by a control or controls actuated externally to a brewing container. The objective is to enable precise control of brewing time by convenient external control that avoids the risk of spills.

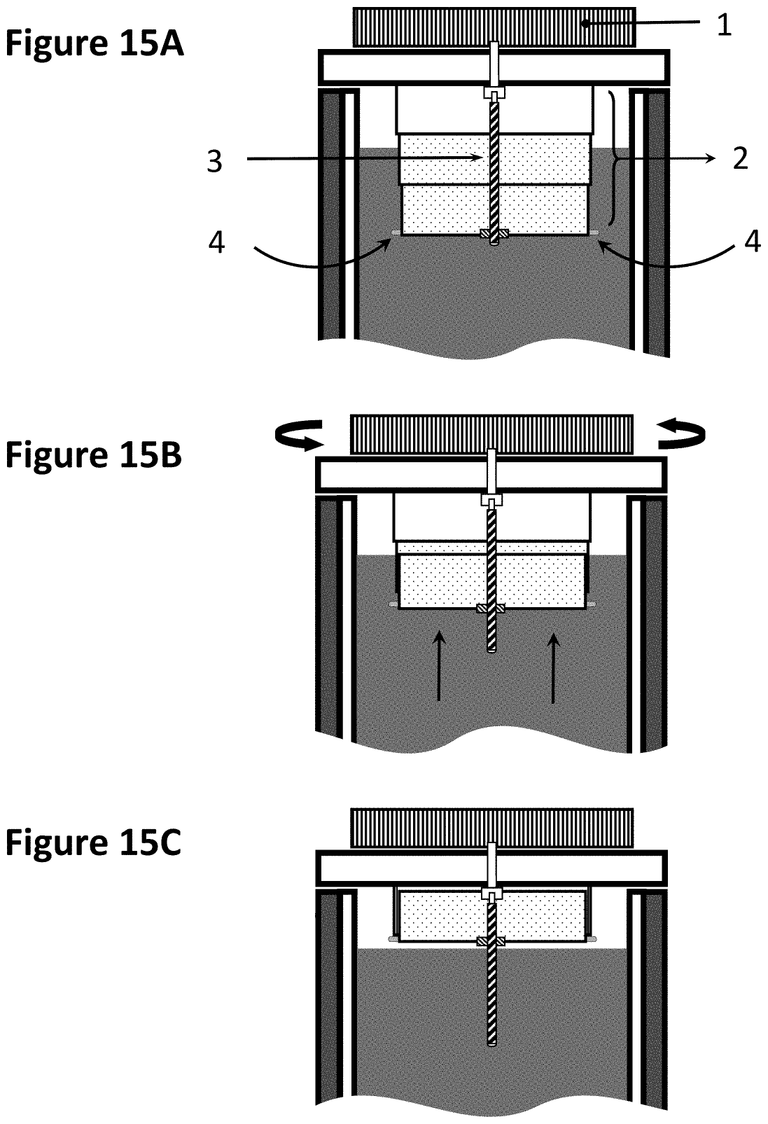

Embodiments may include the cap illustrated in FIGS. 15A-15C, which features a collapsible brewing basket that can: 1) keep tea leaves or ground coffee dry during transport; 2) expand to allow brewing when desired; and 3) close again to stop brewing. Brewing functions can be completely controlled via an external dial, so the user can enjoy fresh coffee or tea brewed on the spot without the risk of spills.

The cap embodiment of FIGS. 15A-15C consists of a brewing dial 1 affixed to the top of the cap via a rotating stem that extends through the cap shell and into the beverage tank. On the underside of the cap is a collapsible brewing basket 2. The basket may be made of stainless steel or other material, and sections may be perforated to allow water to enter and exit during the brewing process. In preferred embodiments, the basket may have several sections, each slightly smaller in diameter than the one above it. The effective volume of the basket can be expanded or contracted like a telescope, by pushing or pulling the sections together or apart.

Basket 2 may be removably mounted under the cap in any one of various well-known ways, including by sliding or snapping into place. Basket 2 is also detachably connected to brewing dial 1 via basket spindle 3, which has threads. Spindle 3's lower end is threaded through a nut fixed in the bottom plate of the basket. Spindle 3's upper end terminates in a connector that mates detachably with the connector at the end of dial 1's stem, in such a way that when dial 1 is rotated in either direction, spindle 3 rotates as well.

The basket does not rotate, however, so when spindle 3 is twisted, its threads raise or lower basket 2's bottom plate.

In preferred embodiments, the side of basket 2's top segment is solid—not perforated like the other basket segments. And the basket's base plate is solid as well. Therefore, when the basket is fully collapsed, as in FIG. 15C, it comprises a watertight compartment under the cap. Gaskets like gasket 4 are deployed where necessary to prevent leaking.

In use, the user takes a travel mug equipped with the brewing cap of FIGS. 15A-15C, fills the tank with hot water, and fills brewing basket 2 with dry tea leaves or ground coffee. He attaches the basket to the underside of the cap and the stem of dial 1, and dials the basket shut and watertight. He screws the cap on the main body, tosses the mug in briefcase or backpack, and heads for work. Later, when he wants to drink, he twists dial 1 to cause the basket to telescope open. When the basket is open, its perforations allow water to inundate the brewing material it had kept dry until then. Its expanded volume when open provides ample space for the steeping tea leaves or coffee particles to swell and release their full flavor. When the user judges that brewing is done, he twists the dial in the opposite direction to collapse the basket and seal off the brewing ingredients from the finished beverage to prevent overbrewing and resultant bitter flavor. He can then consume his fresh-brewed coffee or tea at his leisure.

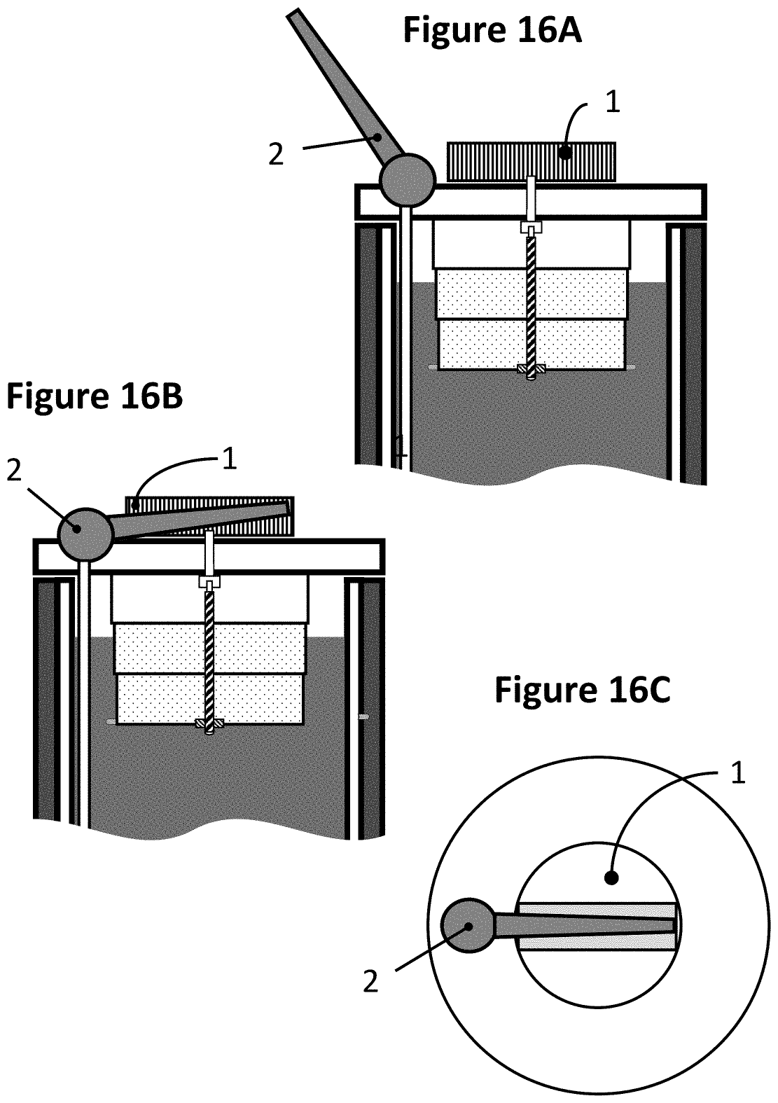

In alternative embodiments, the device may deploy a cap combining a) the removable mouthpiece described earlier and depicted in FIG. 1, and b) the collapsible brewing basket of FIGS. 15A-15C. Such an embodiment is illustrated in FIGS. 16A-16C. Cap 1 may have a central slot into which mouthpiece 2 can fold when not in use. Such a configuration could both protect the mouthpiece from breakage, and prevent accidental rotation of the dial during transport.

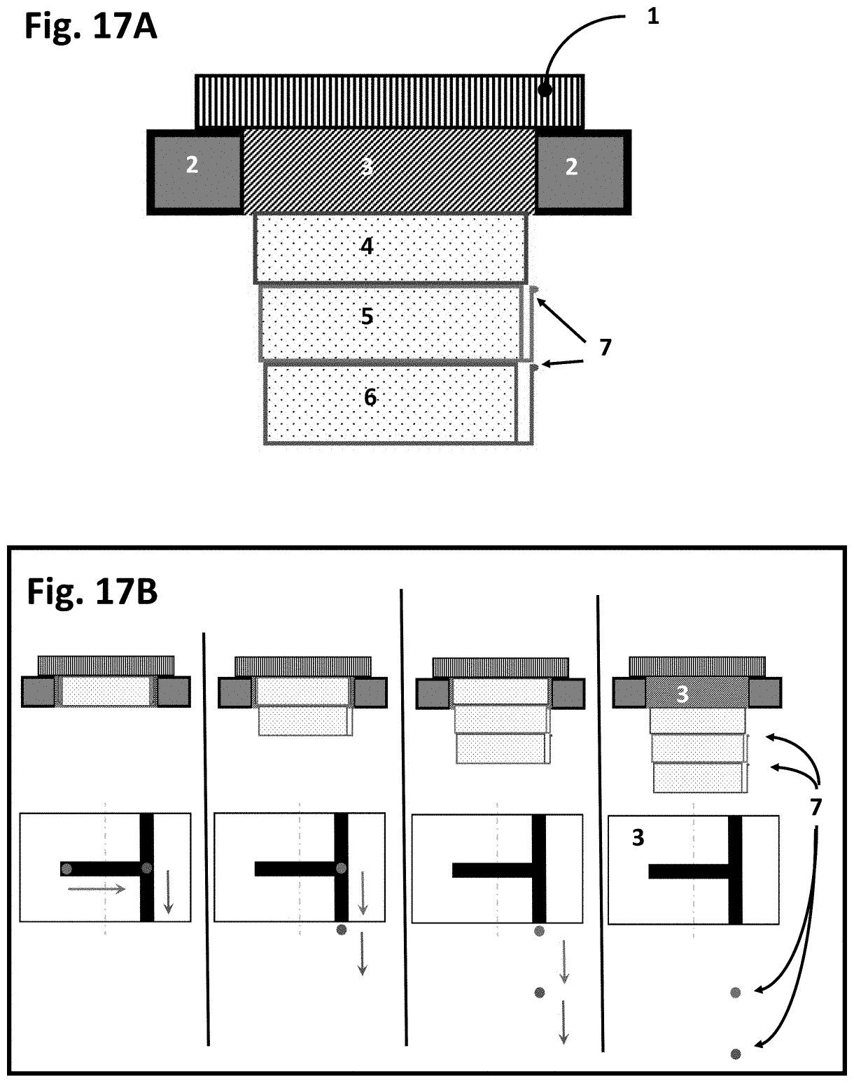

FIG. 17A depicts an alternative embodiment of the cap with brewing basket comprising a knob 1, cap 2, cap cavity 3, and a brewing basket comprising sections 4, 5 and 6. The invention may have more or fewer sections. When collapsed, the three sections in FIG. 17A comprise a compartment in which tea leaves, coffee grounds, or other wet or dry flavor ingredients can be deposited.

The leaves or grounds remain separated from the liquid in the travel mug or other brewing container by a watertight seal around all edges and surfaces of the collapsed basket. The bottom surface of the basket may be solid to contribute to the watertight sealing, or a solid plate may be made to press against the basket's bottom surface to seal. Basket edges may be sealed by gasket or o-ring, for example. All or some of the basket's sidewall sections may be perforated or mesh, or constructed in whole or part of some otherwise permeable material that will permit brewing liquid to flow into and/or out of the basket's interior when the basket is open or otherwise deployed for brewing.

Each of the bottom two sections is prevented from rotating during deployment by a z-shaped bracket or pin 7 that extends horizontally from the bottom of the section, stretches vertically in the space between the basket and the cavity wall, and then is inserted horizontally into a guide groove in the cavity wall. The guide grooves in the wall of the cap cavity prevent rotation of the bottom two sections as they are deployed.

FIG. 17B shows, across the top, the basket in four stages of deployment, from fully closed to fully open. Below each drawing of the basket, FIG. 17B shows a corresponding frontal panoramic (360-degree) view of the cap cavity wall. In the panoramic views, the cap-cavity guide grooves, and the position of the tips of guide pins 7 relative to those grooves, can be seen. Each basket section may be telescoped away from the section above it within the cap cavity. First the bottom section may be zoomed out, and then the middle section, and finally the top section may be lowered with a push. In other embodiments, any and/or all sections may be zoomed by rotating or by pushing or by a combination of these or other actuating movements.

The bottom section may have a follower that moves within a guide groove in the wall of the middle section that causes the bottom section to zoom out when the middle section is rotated. The middle section may have a follower that moves within a groove in the top section that will cause the middle section to zoom out when the top section is rotated.

The bottom section's z-pin is situated in a vertical cavity-wall groove so that the bottom section never rotates, but can slide up and down.

The middle section's z-pin is situated in a horizontal cavity-wall groove which intersects the vertical cavity-wall groove, so that the middle section can initially rotate but not descend, and after entering the vertical groove, can then descend but not rotate.

In operation, the basket starts collapsed. When the top section is rotated by the user's hand, the middle section rotates with it but does not zoom down because its z-pin is initially lodged in the cavity-wall's horizontal groove. As the middle section rotates, it zooms out the bottom section, which cannot rotate because its z-pin is in the cavity wall's vertical groove.

When the bottom section is fully extended, the middle section's z-pin arrives at the intersection with the vertical cavity-wall groove. As the user continues to rotate the top section, it zooms out the middle section whose z-pin now prevents rotation but allows vertical movement.

When the middle section is fully extended, the top section is lowered to the bottom of the cap cavity with a push, and all 3 sections are submerged.

This invention encompasses alternative mapping, placements, designs and interactions of guide grooves and follower pins, obvious to one skilled in the art, that accomplish the expansion and contraction of sections. The sections may move in a different order than that described in this embodiment or may move simultaneously. There may be one or more guide grooves and/or one or more guide pins in basket sections and cap cavity wall.

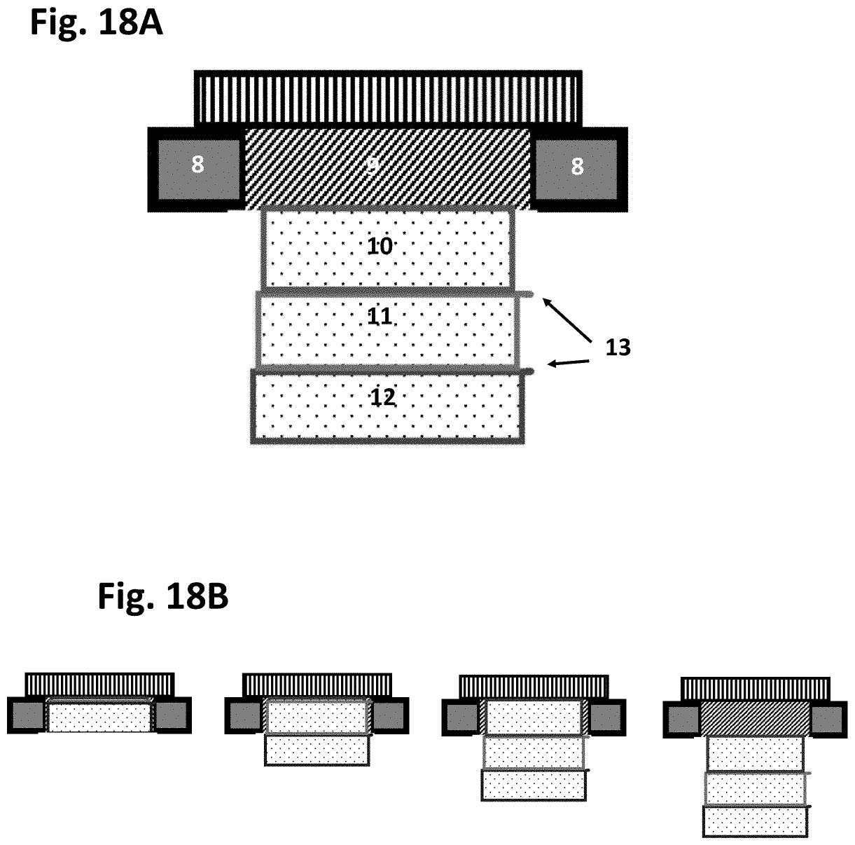

FIG. 18A and FIG. 18B illustrate a preferred embodiment that may function in an arrangement of guide grooves and follower pins, with an outer cap 8, an inner cap lining 9, and telescoping basket sections 10, 11 and 12. In this embodiment, different from that in FIG. 17A and FIG. 17B, the taper of the basket has been inverted, with the widest section at the bottom of the basket when deployed. Also, the guide pins 13 project directly into the cavity wall's grooves from the top of each section, instead of by z-shaped pin affixed to each section's bottom.

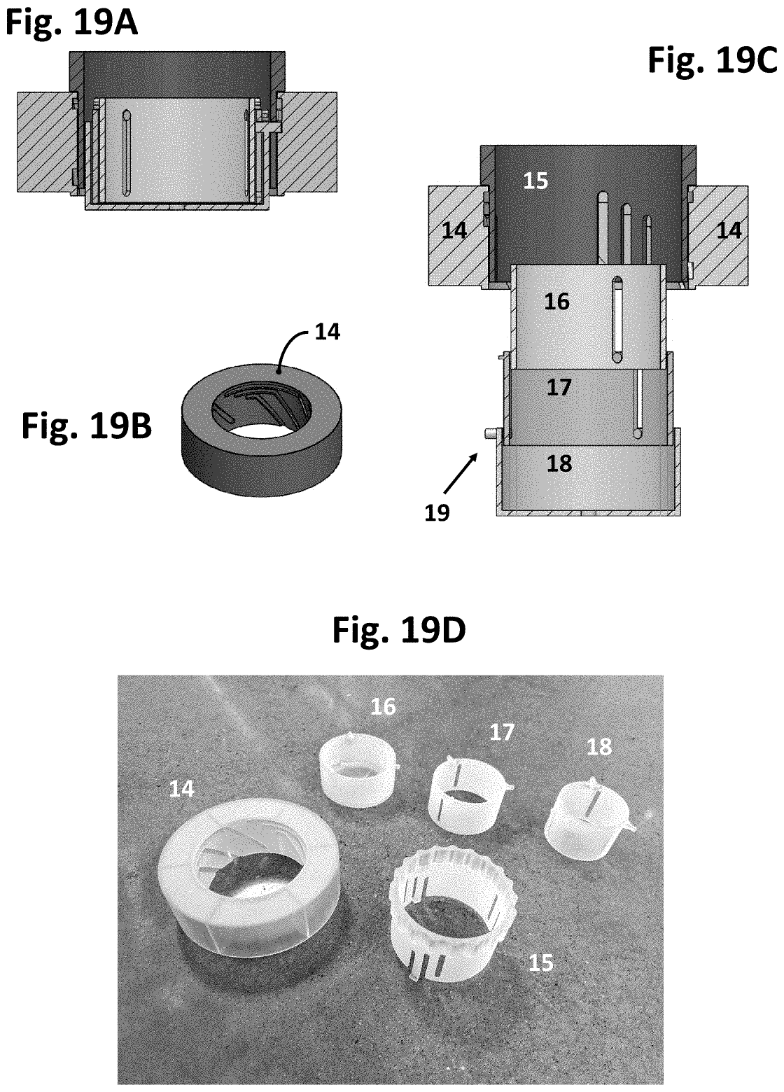

FIGS. 19A-19D further illustrate the telescoping embodiment depicted in FIG. 18A and FIG. 18B. FIG. 19A shows the basket in collapsed position. FIG. 19B shows a view of some of the cap cavity's guide grooves in outer cap 14. FIG. 19C shows the basket in open position. FIG. 19D shows this embodiment's various parts as an outer cap 14, an inner cap sleeve 15, and basket sections 16, 17 and 18. The basket sections may have one or more guide pins 19 projecting from them. There may be one or more guide grooves in basket sections, outer cap 14 and/or inner cap sleeve 15.

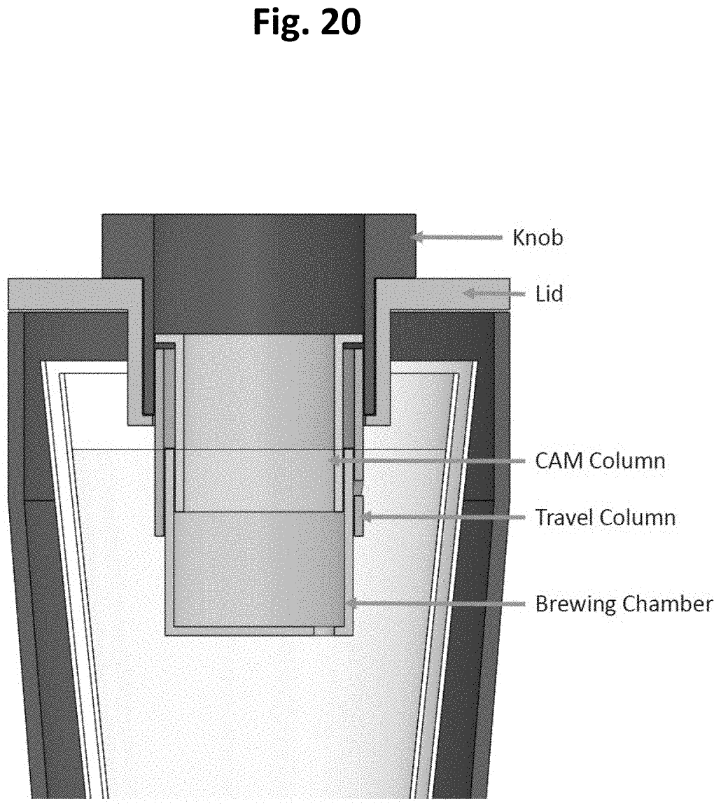

FIG. 20 illustrates an alternative embodiment in which the brewing basket is lowered into the liquid by means of separate cam and travel sections.

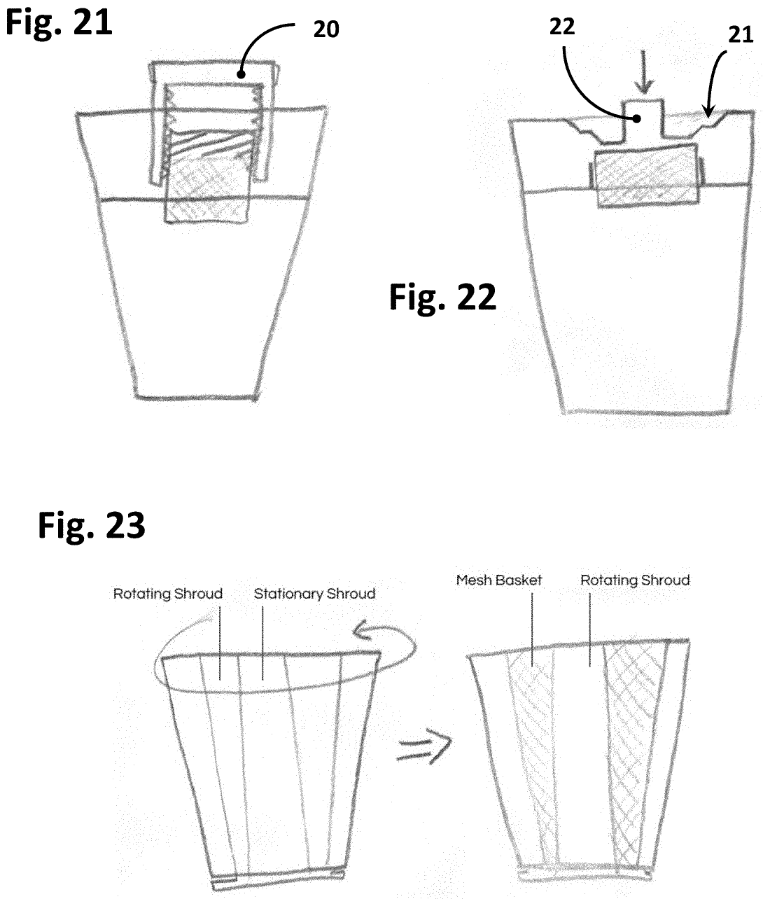

FIG. 21 shows an embodiment having a knob 20 with threads that mate with threads on the mesh or perforated basket to raise or lower the basket.

FIG. 22 shows an embodiment in which the perforated or mesh basket is nested inside a folded elastomeric membrane 21, or other flexible material, that enshrouds the basket in normal position, and that unfolds to submerge the basket in liquid when the external button 22 is pushed. When the button is pulled, the basket retracts. As an alternative to a push/pull knob, in some embodiments the movement can be actuated by turning a dial or by lifting or depressing a lever, among other possibilities.

In preferred embodiments, flexible membrane 21 forms a watertight cover for the basket when collapsed. In some versions, membrane 21 is impermeable, and button 22 seals the top of the basket, so that water can only enter and exit the basket during brewing through the perforated or mesh surfaces of the basket itself. In alternative versions, membrane 21 may itself be perforated or mesh, and button 22 may leave the top of the basket unsealed when the apparatus is deployed, so that during brewing, water may enter the basket both through basket surfaces and permeable membrane 21. In that way, the volume defined by membrane 21 when unfolded might enlarge the effective volume of the brewing basket.

In FIG. 23, the embodiment presents a basket comprising 2 bodies, with perforated, mesh or open sections alternating with solid vanes, panels or shrouds. The bodies are nested tightly together, so that when rotated relative to each other, the solid vanes of one body align with the mesh or perforated panels of the other body to form a solid basket wall that blocks the flow of liquid through it. When rotated to a different position aligning the permeable sections of one body with the perforated or mesh panels of the other body, liquid can pass. The permeable and/or solid sections may be horizontal, vertical, or in some other orientation, and rectangular, circular, or having some other shape.

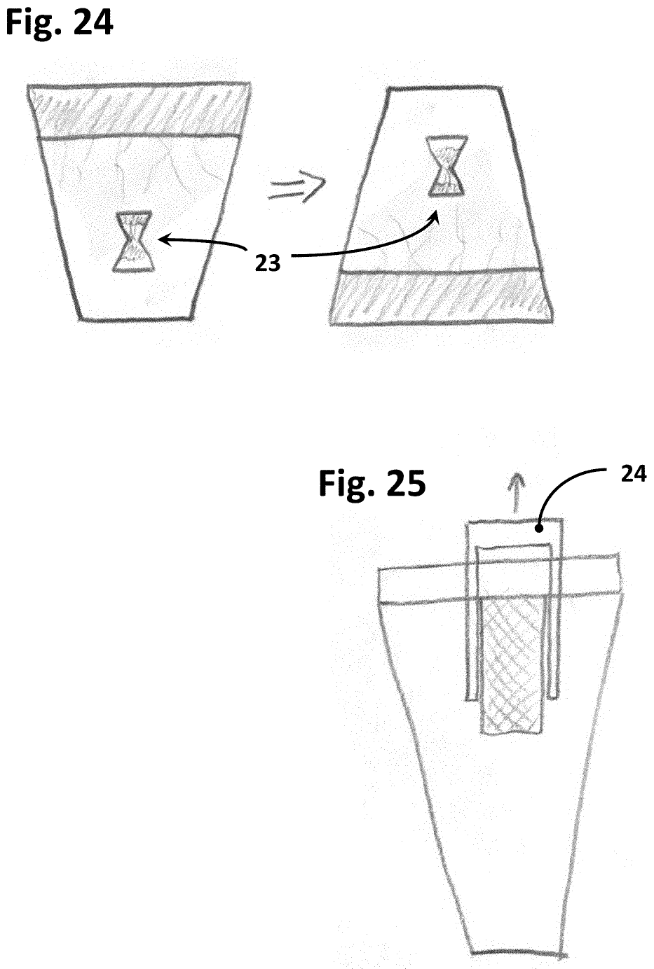

FIG. 24 shows an embodiment in which the brewing basket is located at the top or bottom of the container, so that inverting the container either immerses the contents of the basket in the liquid for brewing, or drains the liquid from the basket. A brewing timer 23 that may resemble a capsule or hourglass with a transparent window may be affixed to or embedded in the exterior of the container to mark the passage of time after the container is inverted by the movement of granules or liquid from one end of the capsule or hourglass to the other. In some embodiments, the brewing timer may be invertible independently of the container.

FIG. 25 illustrates an embodiment in which a solid, impermeable shroud 24 is pulled up to reveal the perforated or mesh basket and allow the passage of water through the basket for brewing. Lowering the shroud would seal the basket again.

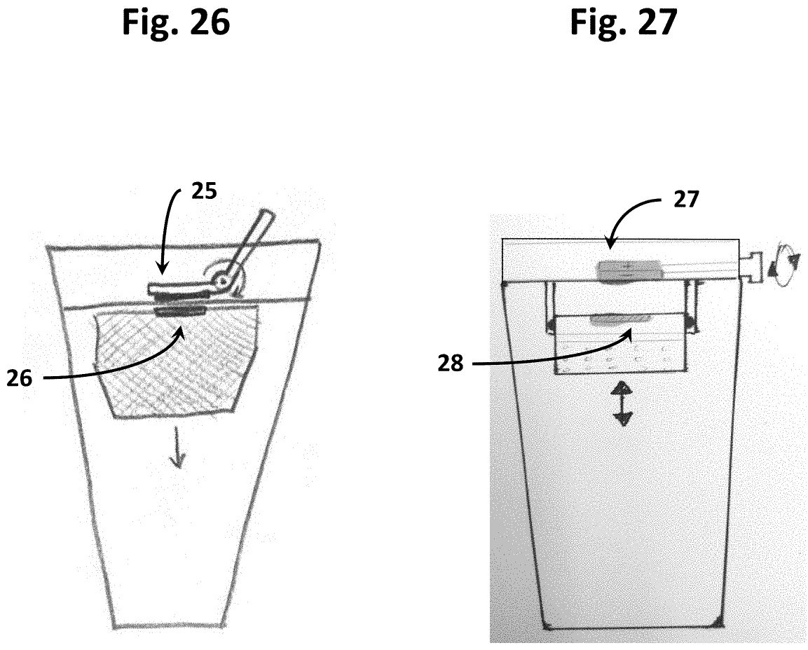

In FIG. 26, the embodiment comprises a magnetic coupling with one or more magnets 25 in the cap and/or one or more magnets 26 in the brewing basket. When actuated, the coupling secures the brewing basket at the top of the container and separate from liquid in the container. In preferred embodiments, the basket is isolated from the liquid in a watertight sheath or niche. When the coupling is released, the basket drops by gravity into contact with the liquid for brewing. The container might then be inverted, and the magnetic coupling reactivated, to reconnect basket and cap.

The embodiment in FIG. 27 comprises a magnet 27 in the cap that can be rotated, flipped or otherwise repositioned by turning a knob or some other method, so that the polarity of the side or end of the magnet facing downward can be reversed from positive to negative and vice-versa. It also may comprise a magnet 28 in the brewing basket. When cap magnet 27 is oriented with its poles in one position, it attracts the magnet in the basket and holds the basket at the top of the container and, in preferred embodiments, in a watertight sheath or niche. When the magnet 27 is rotated or flipped, it repels magnet 28 in the brewing basket and sends the basket down into contact with the liquid. The basket can be reconnected to the top by again reversing the polarity of magnet 27.

The invention also comprises a beverage container equipped with the brewing basket apparatus described above.

To summarize, the advantages offered by the cap with collapsible brewing basket include enabling the user:
to carry all the ingredients necessary for on-the-go brewing in a single container, for convenience
to keep enclosed tea leaves or ground coffee dry until ready for use, for freshest flavor
to mix water and brewing ingredients by external dial without opening the device, for convenience and to eliminate the risk of spills
to remove tea leaves or coffee grounds from the beverage after brewing, also by external dial, to prevent beverage bitterness
to enjoy the full flavor delivered by a large brewing basket in a device that is compact because the basket collapses when not brewing
to brew tea safely on the spot, in moving or active environments, and while engaging in other activities, where and when never possible before

Any of the cap embodiments described can be used in any embodiment of this invention, as well as on other travel mugs, home or office mugs, insulated bottles, teapots, coffee pots, or vessels of any kind.

In some embodiments, a vacuum can be created in the separation space or channel between beverage cup and PCM compartment by means of: a) a one-way valve whose inlet connects fluidly to the separation space, and whose outlet connects fluidly to the ambient or the exterior of the device; and b) a vacuum pump. The vacuum pump can be any product capable of creating a vacuum, including numerous pumps marketed for the vacuum-sealing of packaging for food, as a non-limiting example. The simplest vacuum pumps for food sealing are extremely inexpensive and portable, and without modification can be used to create an effective vacuum with just 1 or 2 manual pumping strokes. Other compact food vacuum sealers are battery-powered, for more convenience. In one preferred method of use, the user positions the mouth of the vacuum pump over the (smaller) opening of the one-way valve of the invention. He or she then presses down so as to make a hermetic seal against the invention's exterior wall, and around the valve opening. Next, the user actuates the pump to suction out, through the valve, the air within the separation channel between beverage cup and PCM. When the user removes the pump from the exterior of the invention, the one-way valve will retain the vacuum just created.

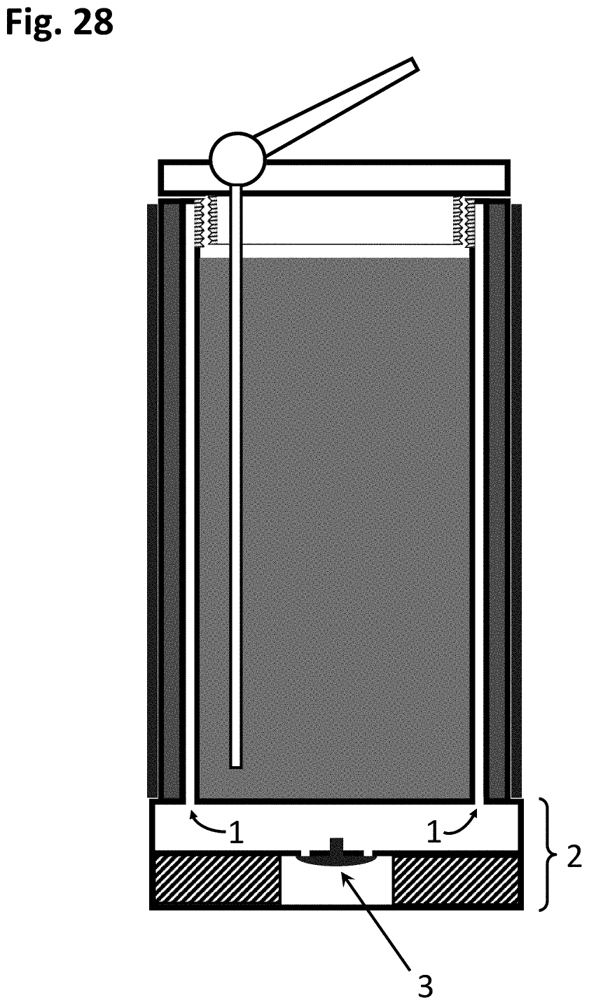

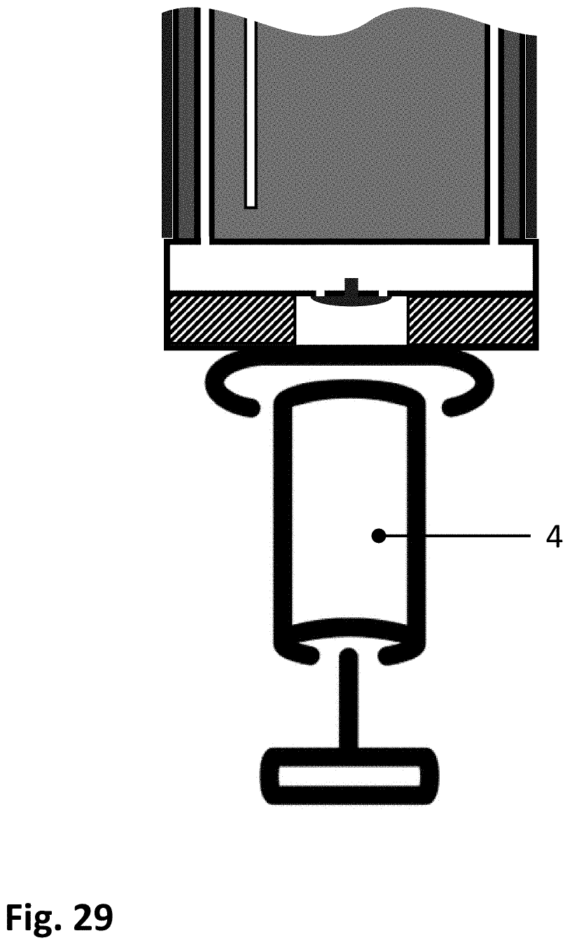

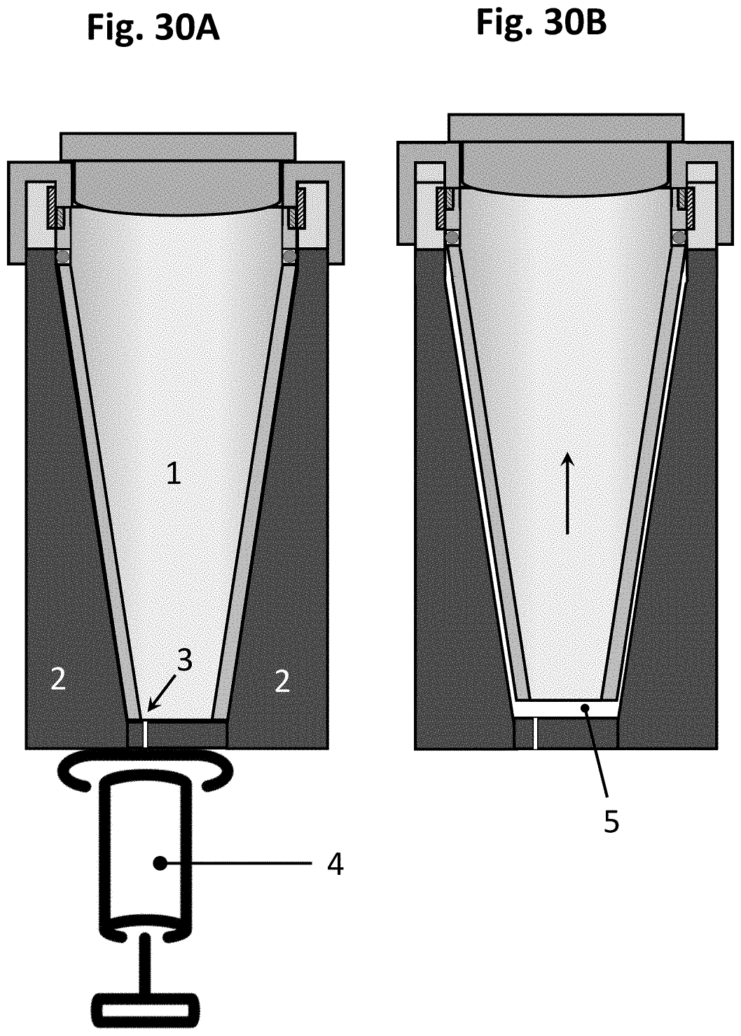

FIG. 28 shows an embodiment of the invention featuring separation channel 1 between the device's beverage tank and PCM chamber, bottom plate 2, and one-way valve 3 set into bottom plate 2. The sides of bottom plate 2 define a void at the top. This void has fluid communication with separation channel 1. The inlet of one-way valve 3 opens onto the void in bottom plate 2, so the valve also has fluid communication with separation channel 1. The outlet of one-way valve 3 opens to the ambient. The valve illustrated is of the umbrella type, whose flexible top unblocks or blocks the hole or holes beneath it to pass air in only one direction. However, there are many different well-known types of check valve that will work equally well, and all types are comprised by this disclosure. In FIG. 29, a vacuum pump of any suitable type is hermetically sealed over the exterior opening of one-way valve 3, either by simple pressure (as illustrated), or by any other suitable means. In use, the user actuates the vacuum pump, which causes air within separation channel 1 and bottom plate 2 to rush out through one-way valve 3 and leave an insulating vacuum in its place. When the user stops vacuuming, one-way valve 3 closes again, and the vacuum is retained. In embodiments, bottom plate 2 can be removable to allow the user to insert into separation channel 1 a thermally conductive sleeve, to cool beverage for drinking, in exactly the same way described for the embodiment of FIGS. 1-6 above. Bottom plate 2 may be supplied with the gasketing needed to ensure an airtight seal with the device's main body when attached.

The one-way valve and a vacuum pump can also be used in tandem with other means of vacuum generation to produce a vacuum of higher quality. The manufacture of vacuum-insulated thermal containers typically requires suctioning the vacuum-insulation channel with powerful machines. Significantly, this invention can generate a vacuum of 99% quality or more in a minute, with a stroke of a $10 pump and a few twists of the wrist. A preferred procedure is illustrated in FIGS. 30A and 30B, which, as an example, show an embodiment in which beverage cup 1 moves axially to separate from PCM compartment 2 to create separation space 5. The figures show one-way valve 3 and vacuum pump 4, which may be of any suitable type. In a preferred procedure, beverage tank 1 and PCM compartment 2 are screwed together, as in FIG. 30A. Vacuum pump 4 is then connected to one-way valve 3, and the pump is actuated to evacuate, through the valve, any air that might occupy nooks within the separation space despite the close fitting of the parts. After a few seconds, the pump is removed, and one-way valve 3 retains the useful vacuum created. Then, as shown in FIG. 30B, beverage tank 1 and PCM compartment 2 are screwed apart. This action expands the space within which the air molecules left by the vacuum pump distribute themselves, and an even higher-quality vacuum is the result. The user benefits by enjoying liquid that will stay hot in the beverage tank for an even longer time than with a vacuum created either by suctioning or by separation of parts alone.

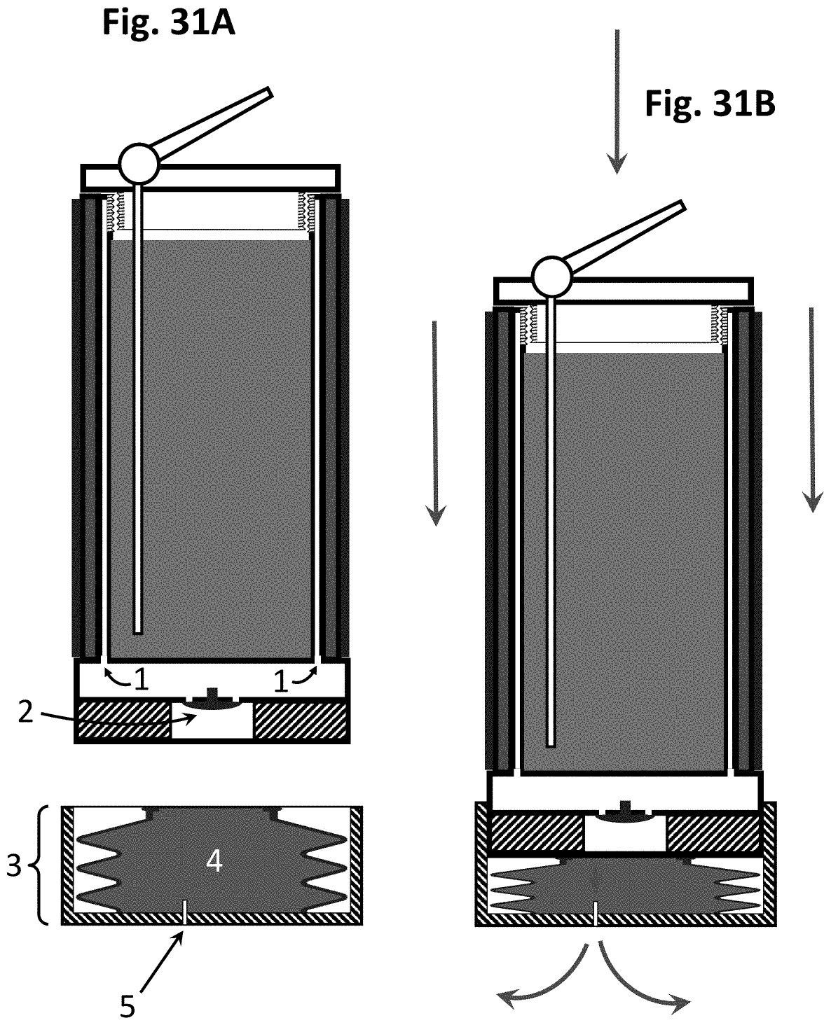

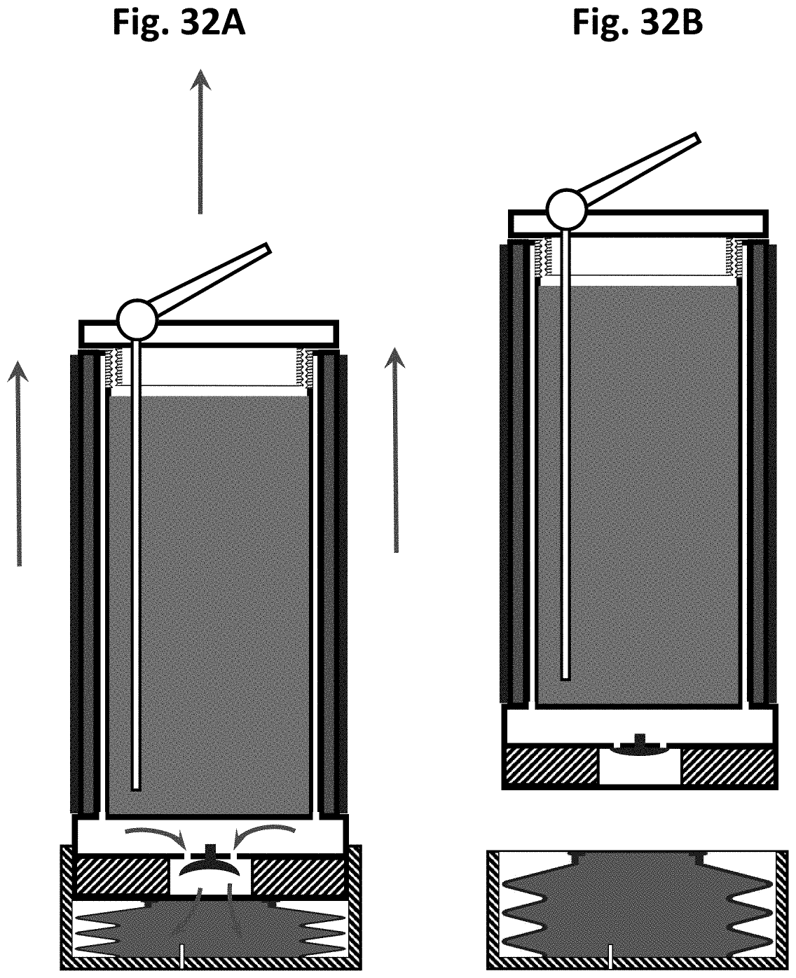

Whatever form of vacuum pump is used, the pump can be attached to the valve opening by direct pressing, by intermediate suction cup and/or tube, or in many other well-known ways. FIGS. 31A and 31B illustrate one example of a preferred pump and connection combination that offers speed and convenience. FIG. 31A shows an embodiment having a separation channel in fluid communication with one-way valve 2 deployed in the travel mug's bottom plate. Pump unit 3 comprises a rigid sidewall and bottom that house bellows 4, which is vertically compressible. There is an air inlet at the top of the bellows, and an air outlet through one-way valve 5 at the bottom of the unit. FIG. 31B shows that when the mug is set into pump unit 3, the opening at the top of bellows 4 seals hermetically around the opening of the mug's one-way valve 2. As the user presses the mug all the way down into the pump unit, bellows 4 collapses and the air that was in the bellows is forced out of the unit's one-way valve 5. When the user then starts to lift the mug out of the pump unit again, as shown in FIG. 32A, the vacuum being created within the bellows causes air in the mug's separation space and bottom plate to rush out through the mug's one-way valve 2 into the expanding, empty space of the bellows. After repeating the plunging action a few times, an effective vacuum will be created within the mug, and the device can be removed for use, as in FIG. 32B. To keep mug and bellows joined together during pumping, a simple twist-lock, threaded, magnetic, hook-and-loop, adhesive, or other kind of connector may be used. The pump unit can be handheld or anchored to a surface during operation. While the illustrated pump-unit deploys a bellows, other mechanical compression pumps, like a piston type, for a non-limiting example, are also encompassed by this invention. In embodiments, the pump unit, which is essentially a docking base or guiding sleeve, is configured for use with mechanical pump types that are not axially compressible, with battery-powered or electric-powered pumps, with pumps that may be external to the docking base or sleeve, and with pumps that may not come into direct contact with the mug.

The drawings and descriptions given here are illustrative embodiments of the invention, which encompasses all obvious variations, and variations known to those skilled in the art, including but not limited to variations in material, means of attachment or connection, and specific structure. For example, but without limitation, the cooling material in sleeve 3 of FIG. 7A and elsewhere, described as preferably PCM, could alternatively be a solid heat sink of metal or ceramic, or the ambient air, or a thermoelectric cooler, among many alternatives known to those skilled in the art. The stem of dial 1 of the brewing cap in FIGS. 15A-15C is depicted as terminating in a U-shaped yoke connector. As drawn, the top end of spindle 3 has a paddle shape that would allow stem and spindle to be connected when the user snapped or slid the basket into place underneath the cap. However, there are innumerable means of detachably connecting the two parts, like, for (non-limiting) examples, pins, clamps, clips, and screwing or twist-lock mechanisms. The basket itself need not be made of perforated rigid metal or plastic, but could have sides of flexible or elastic mesh that unfold and fold like an accordion, or stretch and contract, instead of telescoping open and closed.

In all embodiments, the PCM compartment could be a detachable, modular unit that the user could exchange for other modules containing PCM with different characteristics, including different melting temperatures, so that he could choose and vary the end drinking temperature of beverage dispensed by his device. Some embodiments may dispense with a cooling-material compartment altogether, and first insulate and then thermally connect the beverage tank to the cooling ambient air.

Thermal pads and other gap fillers may be used advantageously by all embodiments that promote heat transfer between components that do not have a common wall. In all such embodiments, a thin, thermally conductive pad or other medium may be deployed between mating beverage tank and PCM sleeve to compensate for surface irregularities and improve thermal conductivity across the interface. The pad or other thermal gap filler may have adhesive on one side, for permanent fixture to only one component, and no adhesive on the other side, to facilitate the repeated connection and separation of components required for mode changes.

All embodiments depicted here, as devices permitting the reversible thermal insulation of the beverage tank, can deliver faster cooling times than prior art by deploying PCM with a melting point lower than the target drinking temperature. The rate of cooling is proportional to the difference in temperature (ΔT) between beverage and cooling agent: the greater the temperature difference, the faster the cooling. Other products deploy PCM that melts at about 140° F. because once the beverage is cooled to this desired drinking temperature, the PCM—itself now 140° F.—will keep the beverage 140° F. until the user has leisurely consumed it. In those products, the beverage cools dramatically in the first moments, when it is hottest, while cooling slows dramatically for the last few degrees, when ΔT is small. Were those products to employ PCM with a lower melting point (100° F., for example), the PCM would have a lower temperature during cooling, the ΔT (beverage to PCM) would be greater, and the time to cool beverage to 140° F. would be shorter. Unfortunately, however, in that case cooling would not stop at 140° F., but would continue until the beverage was as cold as the PCM (100° F.)—and that would be too cold.

By contrast, the present invention disclosed here, featuring reversible thermal insulation and connectivity, can: a) transport a hot beverage and maintain its hot temperature for hours by vacuum insulation; b) thermally connect the beverage to PCM with a melting point (for example, 100° F.) lower than target drinking temperature; c) quickly cool the beverage to target temperature (around 140° F.) by virtue of a large ΔT; and d) reestablish a vacuum envelope to insulate the beverage at target temperature (140° F.) for as long a time as the consumer may need to drink it. A concomitant benefit of the ability to reverse the connection of beverage to PCM is that the user can choose to stop cooling at any temperature that suits him, instead of having to drink his coffee or tea at the invariable and pre-determined temperature equal to the melting point of the PCM.

Embodiments of this invention, accordingly, may deploy a means for informing the user of the beverage temperature, as, for example and without limitation, by analog or digital thermometer, perhaps similar to a meat thermometer, that is permanently integrated into the device, whose probe penetrates the device's cap or side, to sense temperature of beverage tank or beverage, and whose display is externally visible; or by thermochromic paint or other material on cap or side, similarly thermally connected to tank or beverage, that changes color to signal beverage temperature; or by electronic or electromechanical (bimetallic-strip) sensor, powered by external AC or DC source, or integrated solar, mechanical, chemical, or other power-generating mechanism or battery, with an external display either on the device, or on a remote display/controller like a cell phone.

This invention encompasses embodiments in which the functions of connecting and/or separating beverage tank and PCM sleeve or other components, and other physical functions, are accomplished by mechanical or electromechanical means, like, for example and without limitation, wax motors or electric motors.

All embodiments may feature an integrated heating element enabling the user to heat water or beverage to a desired temperature, and/or to maintain liquid at a desired temperature.

All functions of all embodiments described in this document can be powered, controlled and monitored as described in preceding paragraphs and in other ways, including remotely via Bluetooth or other means of connectivity to smartphones, computers, or other devices capable of such monitoring and control. And any function may be programmed to occur automatically, as appropriate for the user's purpose. For example, the device may be programmed to actuate a motor that separates beverage tank and PCM sleeve automatically, and without additional user attention, when the beverage reaches the desired drinking temperature.

This invention encompasses embodiments of any size and capacity, including (without limitation) compact travel mugs portable in briefcase, handbag or backpack, and operable in car or train, park or lecture hall while being held in one hand, as well as versions that may be larger or attached to external power sources or used mostly on kitchen or cafeteria countertop.

Although this description portrays the invention as facilitating the brewing of hot tea or coffee, it may be used to prepare any hot beverage involving brewing, infusing or mixing, including herbal drinks and hot chocolate. It may also be used to transport and then cool hot beverages that have been prepared outside of the device and poured in already made. It may also be used in applications outside of the beverage field, as in pharmaceutical, medical, scientific or industrial testing or processes.

In addition, the invention may be used, in any application, to deliver the reverse effect from that described above: it can transport a cold substance and maintain its temperature via vacuum insulation, and then upon demand, eliminate the insulation to facilitate warming.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A beverage container comprising:
a compartment to hold a consumable liquid;
a cooling mechanism for reducing the temperature of the liquid before consumption; and
a variable insulating space located between the compartment and cooling mechanism, wherein the variable insulating space can be opened to preserve the liquid's heat when desired.

2. The beverage container of claim 1 wherein the cooling mechanism contains a phase change material.

3. The beverage container of claim 1 wherein the insulating space contains an at least partial vacuum.

4. The beverage container of claim 1 wherein opening the insulating space creates or enhances an at least partial vacuum.

5. A beverage container comprising:
a compartment to hold a consumable liquid;
a cooling mechanism configured to reduce the temperature of the liquid;
an insulating space located between the liquid compartment and cooling mechanism to preserve the liquid's heat;
a contact space located between the liquid compartment and cooling mechanism where liquid and cooling mechanism can come into thermal contact to cool the liquid; and
an opening between the liquid compartment and cooling mechanism that can be blocked to confine liquid to the liquid compartment, or unblocked to let liquid flow into the contact space.

6. The beverage container of claim 5 wherein the insulating space can be converted into the contact space by passing the liquid into the insulating space.

7. The beverage container of claim 5 wherein the insulating space is an at least partial vacuum.

8. The beverage container of claim 5 wherein the cooling mechanism contains a phase change material.

9. The beverage container of claim 5 wherein the said opening between the liquid compartment and cooling mechanism is created by the at least partial separation of at least two of the parts comprising the liquid compartment.

10. The container of claim 5 wherein the contact space is created by the relative movement between at least part of the liquid compartment and at least part of the cooling mechanism.

11. A beverage container comprising:
a compartment to hold a consumable liquid;
an insulating space to preserve the liquid's heat; and
a valve that is in fluid communication with the insulating space, and that can be fluidly connected to an internal or external pump to create or enhance an at least partial vacuum in the insulating space.

12. A pump that can be attached to an exterior of a beverage container, the pump comprising:
an outer shell;
a bellows or piston that is within the shell, and that will expel air from the shell when the bellows or piston is depressed;
a unidirectional valve that permits the expulsion of air from the shell by the bellows or piston;
an opening or valve in the bellows or piston that can be connected to an opening or valve in the container to put an interior of the bellows or the space below the piston in fluid communication with the insulating space of the container; and
wherein connecting the container to the bellows or piston, and then depressing and raising the bellows or piston while connected, can create or enhance an at least partial vacuum in the container.

13. A brewing basket for a beverage container comprising:
a sidewall and bottom defining a space where brewing ingredients and a liquid for brewing can interact; and an external control, wherein:
the basket can hold infusing or mixing ingredients separate from a liquid within a container to which the basket is attached or into which it is inserted;
the basket can expand in volume to put brewing ingredients and liquid in contact for brewing, or contract in volume to separate brewing ingredients from the liquid; and
the external control can expand or contract the basket by actuation from an exterior of the container.

14. The brewing basket of claim 13, wherein: the basket comprises a tapering sidewall formed by rigid, concentric sections of progressively smaller or larger diameters that telescope open and closed; at least some of the sections are perforated to permit the passage of liquid; and the basket is substantially watertight when telescoped closed.

15. The brewing basket of claim 13, wherein the basket comprises a flexible mesh or a flexible perforated material that folds or unfolds to increase or contract the effective volume of the basket, and the basket is substantially watertight when the basket is folded closed.

16. The brewing basket of claim 13, wherein the basket can be attached to an underside of a cap for a beverage container.

17. A method of preparing a beverage comprising:
providing a beverage container comprising a compartment to hold a liquid to be consumed and an insulating space to preserve the liquid's heat;
creating or enhancing at least a partial vacuum within the container to preserve the heat of the liquid; and
dispensing the liquid from the container.

18. A method of preparing a beverage comprising:
providing a container comprising a compartment to hold liquid and a cooling mechanism, wherein the thermal communication between the liquid and the cooling mechanism is variable;
creating or enhancing, by a pump mechanism or by separating parts, an at least partial vacuum within the container to preserve the heat of the liquid;
maintaining said liquid in reduced thermal communication with the cooling mechanism while said liquid is hotter than the temperature at which the liquid will be dispensed;
putting ingredients for brewing, infusing or mixing a beverage into contact with the liquid, if desired;
putting the liquid into increased thermal contact with the cooling mechanism; and
dispensing the liquid from the container.
